(19) United States
(12) Patent Application Publication
(10) Pub. No.: US 2004/0076396 A1
(43) Pub. Date: Apr. 22, 2004

(54) Light guiding body, light reflective sheet, surface light source device and liquid crystal display device using the light reflective sheet, and method of manufacturing the light reflective sheet

(76) Inventor: Yoshinori Suga, Mie (JP)

Correspondence Address: WENDEROTH, LIND & PONACK, L.L.P., 2033 K STREET N. W., SUITE 800, WASHINGTON, DC, 20006-1021, US

(21) Appl. No.: 10/467,800

(22) PCT Filed: Feb. 14, 2002
(86) PCT No.: PCT/JP02/01273

(30) Foreign Application Priority Data
Feb. 14, 2001 (JP) 2001-37177
Mar. 21, 2001 (JP) 2001-81328
Apr. 3, 2001 (JP) 2001-105062
May 14, 2001 (JP) 2001-143731
Jul. 9, 2001 (JP) 2001-208608

(51) Int. Cl. G02B 6/10; G02F 1/1335

(52) U.S. Cl. 385/146; 349/65

(57) ABSTRACT

A surface light source device 21 includes a light guide 21, condensing elements 240 provided on a light emitting surface 21b of the light guide 21, a light reflective sheet 27 provided on a surface 21c opposite the light emitting surface 21b. The reflective sheet 27 includes substantially identically and/or substantially analogously shaped base units 28 having inclined light reflecting surfaces and arranged with a pitch not exceeding 5000 micrometers. A light source 22 is provided along one side 21a of the light guide 21. The light guide 21 includes a light takeout mechanism 290 for selectively emitting light beams through the surface 21c opposite the light emitting surface 21b.

### TECHNICAL FIELD TO WHICH THE INVENTION BELONGS

The present invention relates to a light guide and a reflective sheet, a surface light source using the light guide and the reflective sheet, and a liquid crystal display device. More particularly, the present invention relates to a surface light source suitable for use with a display device for a monitor for a personal computer or a thin TV set, a light guide used therefor, and a liquid crystal display device using the surface light source device as a backlight.

The invention also relates to a method of manufacturing a light reflective sheet which is an element of the surface light source.

### PRIOR ART

Nowadays, as display devices for monitors for personal computers and thin TVs, transmission type liquid crystal display devices are used. This type of liquid crystal display devices generally include a surface illumination or backlight (surface light source) behind the liquid crystal elements. The surface light source converts linear light from e.g. a cold cathode discharge tube into a surface light.

Typical methods include arranging a light source right behind and under the liquid crystal elements, and others include providing a light source on one side, and using a light-transmissive light guide, such as an acrylic board, for converting the light from the light source into surface light (sidelight type). These surface light source further includes optical elements such as a prism array on the light-emitting surface to achieve desired optical properties.

Light source assemblies of a sidelight type are disclosed in JP patent publications 61-99187 and 63-62104. A liquid crystal display device is required to be as lightweight and thin as possible. For this purpose, the use of a sidelight type of light source is preferable because it is possible to make the backlight thin. Thus, many of today's liquid crystal display devices, particularly those for portable personal computers, use backlight of a sidelight type.

A typical conventional surface light source assembly of a sidelight type is shown in FIG. 46. It comprises a light guide 1 in the form of a light-transmissive flat board, a linear light source 2 provided along one side 1a of the light guide 1, and a reflector 3 mounted to cover the linear light source 2 so that both the direct light from the light source 2 and the light reflected by the reflector 3 will enter the light guide 1 through its one side 1a that is the light-incoming side.

One surface of the light guide 1 is a light-emitting surface 1b. Over the light-emitting surface 1b, a light-adjusting sheet 5 formed with an array 4 of triangular prisms with their apexes facing the viewer. On the surface 1c of the light guide 1 opposite to the light emitting surface 1b, a light takeout mechanism 6 is provided which is formed with numerous dots 6a of a predetermined pattern printed with a light-scattering ink. On the surface 1c opposite the light emitting surface 1b of the light guide 1, on which is formed the light takeout mechanism 6, a reflective sheet 7 is provided adjacent this surface 1c.

FIG. 47 shows another typical conventional surface light source assembly of this type. It includes a light-adjusting sheet 5 provided over the light emitting surface 1b and formed with an array 4 of triangular prisms so that their apexes will face the light-emitting surface 1b. The light takeout mechanism 6, which is provided on the surface 1c of the light guide 1 opposite to the light emitting surface 1b, is formed with numerous dots 6b forming a rough-surface pattern.

Since such sidelight type of surface light source assemblies helps the light weight and thinness of liquid crystal display devices, they are used as backlight for liquid crystal display devices for e.g. portable personal computers.

### PROBLEMS THE INVENTION TACKLES

But these conventional transmission type liquid crystal display devices are still complicated in structure. The reason therefor mainly lies in that for such conventional surface light source assemblies, illuminating optical system has been unavailable which provides good light utilizing efficiency with a simple structure. In other words, such conventional light source assemblies are complicated in structure and thus costly. This is one of major reasons why this type of liquid crystal display devices are not very popular yet.

As shown in FIGS. 46 and 47, typical conventional surface light source assemblies used as backlight optical system for transmission type liquid crystal display devices include an optical sheet such as a prism sheet to utilize illuminating light from the surface light source as effectively as possible. This naturally complicates the structure of the illumination optical system, thus worsening the assembling efficiency and yield, which leads to high cost.

The inventors of the present application proposed a surface light source assembly 10 shown in FIG. 48 as a means for solving the abovementioned problems. This surface light source assembly 10 comprises a light guide 11 having condensing elements 12 integrally formed in the form of a prism array on its light-emitting surface, and a linear light source 2 covered with a reflector 3 and provided on one side 11a of the light guide 11 in the same manner as with the light source assemblies shown in FIGS. 46 and 47. It further includes a light reflective sheet 14 provided on a surface 11c opposite to the light emitting surface 11b of the lightly light guide 11 and having a large number of identically shaped base units 13 each having an inclined light reflective surface 13a.

With this surface light source device 10, the light guide 11 is designed such that most part of the light emitting from the light guide 11 will be selectively directed toward the reflective sheet 14. By forming an optical system in which a large number of substantially identically shaped base units 13 comprising inclined light reflecting surfaces 13a are arranged on the surface of the light reflective sheet 14, a light source assembly is provided which is extremely high in optical efficiency even though it does not use a light adjusting sheet complicating the structure.

In particular, by forming a light takeout mechanism 15 comprising convex protrusions 15a having smooth surfaces having a sufficiently large height relative to the width as shown in FIG. 50 on the surface 11c of the light guide 11, and controlling the light emitting direction using the light takeout mechanism 15, it becomes easy to intensively direct the light beams from the light guide 11 toward the light reflective sheet 14, and also if it is large in size, a mold can be formed easily, so that a surface light source device is obtained that is extremely rich in practicality.

Further, by forming a light takeout mechanism 14 comprising convex protrusions 14a having smooth surfaces having a sufficiently large height relative to the width as shown in FIG. 49 on the surface 11c of the light guide 11, and controlling the light emitting direction using the light takeout mechanism 14, it becomes easy to intensively direct the light beams from the light guide 11 toward the light reflective sheet 12, and also if it is large in size, a mold can be formed easily, so that a surface light source device is obtained that is extremely rich in practicality.

Also, it has been found out that by providing a condensing element 12 in the form of an array of triangular prisms on the light-emitting surface 11b of the light guide 11, it is possible to provide an optical system which has excellent light condensing property and is extremely efficient. Specifically, the light leaving the light guide 11 is directed toward the reflective sheet 14 as shown by arrows 16 in FIGS. 48 and 50B, reflected by the reflective sheet 14 back into the light guide 11, and utilized as illuminating light 17 (FIG. 48). Thus, the light guide itself serves as a prism sheet. It becomes possible to achieve excellent light condensing characteristics different from the light path 8 of FIG. 45 in the conventional surface light source device.

If this light source assembly is put into practical use as a backlight for a large liquid crystal display, there is a problem. Namely, the light takeout mechanism 15 used in conventional surface light source assemblies ordinarily have a simple pattern that a large number of protrusions 15a have such sectional areas as to increase gradually as they are farther from the light source 2 (see FIGS. 50A and 51). In such an arrangement, it is extremely difficult to achieve uniform illumination. Also, since the light emitting angle varies at different points of the light-emitting surface 11b, unevenness in illumination tends to be conspicuous when viewed obliquely. This deteriorates the quality of images.

Thus, while the conventional optical device has many excellent characteristics, due to their extremely simple structure of the optical system compared to older surface light source assemblies, unevenness in brightness due to wave optical mechanisms such as interference fringes (moire fringes) tends to develop. Even ugly unevenness may sometimes appear on the light-emitting surface. This poses quality problems if this device is used as a backlight for large liquid crystal displays.

In order to achieve higher optical properties, it is necessary that light beams from the light guide be sufficiently condensed. But because the above-described conventional optical system is extremely simple in structure, no sufficiently condensed light is emitted from the light guide with a conventionally used simple light takeout mechanism. Thus, efficiency of illumination was limited. This made it difficult to use this technique in field where high illumination efficiency is required, such as displays for cell phones and hand-held computers.

Further, while these optical systems have superior characteristics as mentioned above, since they are extremely simple in optical structure compared to conventional surface light source assemblies, if they are used with surface light source assemblies for which high accuracy is required, e.g. for large liquid crystal displays, the positional relationship between the light reflective sheet and the light guide cannot be retained with high accuracy. This would directly influence the quality of illumination by the surface light source, causing unfavorable unevenness in appearance. Also, no method for efficiently manufacturing light reflective sheets was available. Thus, it was difficult to mass-produce them at a low cost.

An object of the present invention, which was made to solve these problems, is to improve the surface light source device which was proposed by the present inventors and is simple in structure and superior in illuminating efficiency and provide a light guide which is inexpensive and superior in optical efficiency and assemblability to achieve optical properties sufficient for use as a backlight of a large liquid crystal display device, a surface light source device using it, and a liquid crystal display device using it as a back light optical system.

Another object of the present invention is to provide a light reflective sheet which is of high quality and easy to manufacture and which is needed to realize an optical system having sufficient optical properties (quality and appearance) for use as a backlight of a large liquid crystal display device to provide a method of manufacturing the light reflective sheet efficiently at a low cost in a mass-production scale, and to provide a surface light source device and a liquid crystal display device having an optical system which is simple in structure and superior in the illuminating efficiency by using the light reflective sheet.

### MEANS TO SOLVE THE PROBLEMS

According to the present invention, there is provided a light guide for use with a surface light source device, the light guide comprising a light emitting surface on one surface thereof and a light takeout mechanism formed on a surface opposite the light emitting surface and comprising directional light emitting elements each having a smooth surface, the directional light emitting elements emitting at least 65% or more of light beams from the light guide through the surface opposite the light emitting surface.

From another aspect of this invention, there is provided a surface light source device comprising a light guide having a light emitting surface on one surface thereof, condensing elements provided on the light emitting surface, a light source provided along one side of the light guide, and a light reflective sheet provided on a surface of the light guide opposite the light emitting surface, the light guide having on the surface opposite the light emitting surface a light takeout mechanism comprising directional light emitting elements each having a smooth surface, the reflective sheet having a multiplicity of substantially analogously shaped base units each having an inclined surface having a reflectance of 70% or higher and arranged with a pitch of 5000 micrometers or less.

From still another aspect of the invention, there is provided a light guide for use with a surface light source device, the light guide comprising a light emitting surface on one surface thereof and a light takeout mechanism for selectively emitting light beams through a surface opposite the light emitting surface, the emitting direction selectivity rate as measured at any point in the light emitting surface being substantially constant.

From a further aspect of the invention, there is provided a light guide for use with a surface light source device, the light guide having a light emitting surface on one surface thereof, and a light reflective sheet provided on a surface opposite the light emitting surface and comprising a multiplicity of substantially identically and/or substantially analogously shaped base units each having an inclined light reflective surface, and a light source provided along one side of the light guide, characterized in that the light guide includes a light takeout mechanism for selectively emitting a major portion of illuminating light beams through the surface opposite the light emitting surface, and the light takeout mechanism has an irregular pattern.

From yet another aspect of the invention, there is provided a light guide having a light incoming surface at one side thereof and a light emitting surface on one surface thereof, the light guide including a light takeout mechanism comprising protrusions for emitting a major portion of illuminating light through a surface opposite the light emitting surface, the protrusions protruding in a direction in which a major portion of the illuminating light proceeds as viewed from right over the light emitting surface.

From another aspect of this invention, there is provided a light reflective sheet comprising a surface layer formed with substantially identically and/or substantially analogously shaped base units having inclined light reflecting surfaces and arranged with a pitch not exceeding 5000 micrometers, and a backing layer supporting the surface layer, the backing layer being made from a biaxially oriented thermoplastic resin film.

### SPECIFIC STRUCTURES OF THE PRESENT INVENTION

The surface light source device of the present invention includes essential components described above, but it works satisfactorily if these components are as described below. In the surface light source assembly, the directional light emitting elements may be adapted to emit at least 65% or more of light beams from the light guide toward the reflective sheet.

Also, the directional light emitting elements are preferably protrusions each having a smooth surface which has an arithmetic average roughness Ra of 0.01-10 micrometers. Preferably, each of the protrusions has a depth h and a minimum opening width W min, and the ratio h/W min being 0.5 or higher. Further, each of the protrusions preferably has a depth h and a maximum opening width W max, the ratio h/W max of 0.3 or higher.

Further in the surface light source assembly of this invention, each of the protrusions preferably have an opening width increasing as the distance from the light source increases in one axial direction. Alternatively, the protrusions may be substantially identical in shape and the density of the protrusions may increase as the distance from the light source increases.

Preferably, the condensing elements are in the form of corrugations having ridges extending perpendicular to the side along which the light source is provided and arranged with a pitch of 1-500 micrometers. The corrugations preferably form an array of triangular prism having an apex angle of 70-150 degrees and arranged with a pitch of 5-300 micrometers.

Preferably, the base units of the reflective sheet are chevron-shaped and have ridges arranged substantially parallel to each other. Also, the inclined surfaces of the base units of the reflective sheet preferably have a concave cross-section.

Preferably, the inclined surfaces of the base units of the reflective sheet are in the form of a concave mirror having a maximum diameter of 3000 micrometers of less, and the inclined surfaces are inclined so as to reflect light beams from the light guide in a normal direction of the light guide.

Further, the reflective sheet has a reflective surface comprising a coating layer of silver or aluminum and is covered with a transparent coating layer. Alternatively, the reflective surface of the reflective sheet may be formed from a diffuse reflective white material. Also, according to the present invention, there is provided a liquid crystal display device including as its backlight the surface light source assembly as described above.

The light guide of the present invention includes essential components described above, but it works satisfactorily if these components are as described below. In the light guide, the emitting direction selectivity rate as measured at any point on the light emitting surface is preferably 60-100% and varies in the range of ±30% of the average light emitting direction selectivity rate.

The light takeout mechanism preferably comprises protrusions formed on the surface opposite the light emitting surface and each having a smooth surface. In this case, the protrusions preferably have a protruding amount of 300 micrometers or over, and a depth h and an effective opening width W, the ratio h/W being 0.3-1.5, each of the protrusions having a length increasing in one axial direction as the distance from the light source increases, the one axial direction being parallel to the side of the light guide along which the light source is provided.

From another aspect of the invention, there is provided a surface light source device comprising a light guide having a light emitting surface on one surface thereof, a light takeout mechanism provided on the light guide, a light source provided along one side of the light guide, and a light reflective sheet provided on a surface of the light guide opposite the light emitting surface and having a multiplicity of substantially identically and/or substantially analogously shaped base units each having an inclined light reflective sheet and arranged with a pitch of 5000 micrometers or less, the light takeout mechanism is adapted to selectively emit light beams toward the light reflective sheet and a light emitting direction selectivity rate as measured at any point in the light emitting surface is substantially constant.

The surface light source device of the present invention includes essential components described above, but it works satisfactorily if these components are as described below.

In the surface light source assembly, the emitting direction selectivity rate as measured at any point on the light emitting surface is preferably 60-100% and varies in the range of ±30% of the average light emitting direction selectivity rate. The light takeout preferably comprises protrusions formed on the surface opposite the light emitting surface and each having a smooth surface.

The protrusions have a protruding amount h of 300 micrometers or over, and a depth h and an effective opening width W, the ratio h/w being 0.3-1.5, each of the protrusions having a length increasing in one axial direction as the distance from the light source increases, the one axial direction being parallel to the side of the light guide along which the light source is provided.

Alternatively, the protrusions preferably have a protruding amount of 300 micrometers or over, and a depth h and an effective opening width W, the ratio h/W being 0.3-1.5, and are substantially identical in shape, and the density of the protrusions increases as the distance from the light source increases.

Preferably, the surface light source assembly of the invention further comprises an array of triangular prism arranged with a pitch of 1-500 micrometers and having ridges extending substantially perpendicular to the side along which the light source is provided, and having an apex angle between 150 and 60 degrees. According to the present invention, there is provided a liquid crystal display device including as its backlight the surface light source assembly as described above.

The light guide of the present invention includes essential components described above, but it works satisfactorily if these components are as described below. In the light guide as described above, the emitting direction selectivity rate at or near the center of the light emitting surface is preferably 60-100%.

Preferably, the light guide further comprises condensing elements having ridges extending substantially perpendicular to the side along which the light source is provided, and arranged with a pitch of 1-500 micrometers. Preferably, the condensing elements comprise an array of triangular prism having an apex angle of 60-150 degrees and arranged with a pitch of 10-150 micrometers.

Preferably, the condensing elements comprise an array of triangular prism having an apex angle of 60-150 degrees and arranged with a pitch of 10-150 micrometers. The light takeout mechanism preferably comprises protrusions each having a smooth surface and having a protruding amount of 2-300 micrometers. Preferably, the protrusions are not in contact with each other. Alternatively, the light takeout mechanism may have a dot pattern comprising rough surfaces.

According to this invention. There is also provided a surface light source assembly comprising the light guide described above, and a light source provided at one side of the light guide, and a light reflective sheet arranged on a surface opposite the light emitting surface, substantially identically and/or substantially analogously shaped base units each having a reflective surface being arranged on the reflective sheet with a pitch of not more than 5000 micrometers.

In this surface light source assembly, the inclined surfaces of the base units of the reflective sheet are chevron-shaped and have ridges juxtaposed to those of adjacent ones of the ridges. Preferably, the inclined surfaces of the base units of the reflective sheet have a concave cross-section. According to this invention, a liquid crystal display device is provided which includes as its backlight the surface light source device having the light guide described above.

The light guide of the present invention includes essential components described above, but it works satisfactorily if these components are as described below. In the light guide according to the invention, the emitting direction selectivity rate at or near the center of the light emitting surface is preferably 70-100%.

The protrusions are preferably provided on the surface opposite the light emitting surface, has a protruding amount of 2-300 micrometers, and have a triangular, rectangular or oval cross-section, as viewed from right over the light emitting surface. The protrusions are preferably irregularly arranged as viewed from right over the light emitting surface.

According to this invention, there is also provided a surface light source assembly comprising the light guide described above, a light source provided at one side of the light guide, a light reflective sheet provided to face the surface opposite the light emitting surface, the reflective sheet having substantially identically and/or substantially analogously shaped base units having inclined light reflecting surfaces and arranged with a pitch not exceeding 5000 micrometers.

In this surface light source assembly, the base units of the reflective sheet preferably have a chevron-shaped cross-section and having ridges juxtaposed to those of adjacent base units. The reflecting surfaces of the base units of the reflective sheet preferably have a concave cross-section. According to this invention, a liquid crystal display device is provided which includes as its backlight the surface light source device having the light guide described above.

The light reflective sheet of the present invention includes essential components described above, but it works satisfactorily if these components are as described below. In this light reflective sheet, the biaxially oriented thermoplastic resin film may be a film of polyethylene terephthalate or polypropylene.

The light reflective sheet is preferably warped so as to be convex toward the surface layer. The light reflecting surfaces are preferably formed of a metallic material, and a coating layer of a transparent insulating layer is provided on the material.

According to this invention, there is also provided a method of manufacturing the light reflective sheet, wherein the base units are formed by a roll-to-roll process. In this method, the base units are preferably formed by shape transfer using emboss rolls.

According to this invention, there is also provided a surface light source assembly comprising a light guide having a light emitting surface on one surface thereof, a light takeout mechanism provided on the light guide, a light source provided along one side of the light guide, and the light reflective sheet having features described above being provided to face a surface opposite the light emitting surface.

In the surface light source assembly, the emitting direction selectivity rate at or near the center of the light emitting surface is preferably 60-100%. Preferably, on the light emitting surface of the light guide, condensing elements in the form of an array of triangular prism having ridges extending substantially perpendicular to one side of the light guide and arranged with a pitch of 10-150 micrometers, and having an apex angle of 60-150 degrees are provided.

Preferably, the light takeout mechanism comprises irregularly arranged protrusions each having a smooth surface and a protruding amount of 2-300 micrometers. Preferably, the light takeout mechanism has a pattern comprising irregularly arranged rough surfaces.

According to the invention, there is also provided a liquid crystal display device including as its backlight the surface light source assembly as described above.

### BRIEF DESCRIPTION OF THE DRAWINGS

FIG. 1 is a perspective view schematically showing a main portion of the surface light source device according to one embodiment of the present invention.

FIG. 2 is a perspective view schematically showing the main portion of a surface light source device according to another embodiment of the present invention.

FIGS. 3(a) and 3(b) are plan views schematically showing a light source arranged at one side end of the light guide in the surface light source device of the present invention.

FIGS. 4(a) and 4(b) are a partial plan view and a sectional view along line 4b-4b of the light reflective sheet used in the surface light source device of the present invention which is formed on the surface thereof with a multiplicity of base units having parallel linear and inclined flat reflecting surfaces having their ridges arranged parallel to each other.

FIGS. 5(a) and 5(b) are a partial plan view and a sectional view along line 5b-5b of the light reflective sheet of another form used in the surface light source device of the present invention which is formed on the surface thereof with a multiplicity of base units having parallel linear and inclined flat reflecting surfaces having their ridgelines arranged parallel to each other.

FIGS. 6(a) and 6(b) are a partial plan view and a sectional view along line 6b-6b of the light reflective sheet of still another form used in the surface light source device of the present invention which is formed on the surface thereof with a multiplicity of base units having parallel linear and inclined concave reflecting surfaces having their ridgelines arranged parallel to each other.

FIGS. 7(a) and 7(b) are a partial plan view and a sectional view along line 7b-7b of the light reflective sheet of still another form used in the surface light source device of the present invention which is formed on the surface thereof with a multiplicity of base units having concave inclined reflecting surfaces.

FIGS. 8(a) and 8(b) are a partial plan view and a sectional view along line 8b-8b of the light reflective sheet of still another form used in the surface light source device of the present invention which is formed on the surface thereof with a multiplicity of base units having concave inclined reflecting surfaces.

FIGS. 9(a) and 9(b) are a partial plan view and a sectional view along line 9b-9b of the light reflective sheet of still another form used in the surface light source device of the present invention which is formed on the surface thereof with a multiplicity of base units having concave inclined reflecting surfaces.

FIGS. 10A and 10B are a partial plan view and a sectional view along line 10b-10b of the light reflective sheet of still another form used in the surface light source device of the present invention which is formed on the surface thereof with a multiplicity of base units having concave inclined reflecting surfaces.

FIG. 11(a) is an enlarged sectional view of the inclined flat reflecting surfaces of the base units formed on the light reflective sheet shown in FIG. 4 with the inclination angle of the inclined flat reflecting surfaces shown, and FIG. 11(b) is an enlarged sectional view of the concave inclined surfaces of the base units formed on the light reflective sheet shown in FIG. 6 with the inclination angle of the concave inclined reflecting surfaces shown.

FIG. 12 is an explanatory view showing how the directional selectivity of light beams of the light guide is measured.

FIGS. 13(a) and 13(b) are characteristics views of the light guide showing the emitting angle distribution in the direction opposite the side end where the light source is arranged in measuring the directional selectivity of light beams of the light guide in the present invention by the measuring method shown in FIG. 12.

FIG. 14 is an explanatory view showing, in the surface light source device of the present invention, the locus of light beams which are emitted from the light guide, reflected by the light reflective sheet and emitted in the normal direction with respect to the light emitting surface.

FIGS. 15(a) and 15(b) are sectional views schematically showing forms of the light takeout mechanism comprising a multiplicity of protrusions formed on a surface opposite the light emitting surface of the light guide used as a form of a suitable light takeout mechanism in the surface light source device of the present invention.

FIG. 16 is an enlarged sectional view schematically showing a form of the light takeout mechanism comprising a multiplicity of recesses which can be used as another form of the light takeout mechanism formed on the surface opposite the light emitting surface of the light guide in the surface light source device.

FIG. 17 is an enlarged sectional view schematically showing another form of the light takeout mechanism comprising a multiplicity of recesses formed on the surface opposite the light emitting surface of the light guide in the surface light source device of the present invention.

FIG. 18 is a plan view of the light guide showing 25 measuring points on the surface in measuring the emitting direction selectivity rate in the light guide of the present invention.

FIGS. 19(a) and 19(b) are plan views schematically showing a suitable arrangement pattern of the protrusions forming the light takeout mechanism provided on the light guide.

FIGS. 20(a) to 20(c) are schematic explanatory views showing the definition of the depth h, the minimum opening width W min and the maximum opening width W max for the protrusions forming the light takeout mechanism provided on the light guide.

FIG. 21 is an explanatory view showing why bright lines are not liable to be produced near the area where the light source is provided in the light source device of the present invention.

FIG. 22 is an explanatory view showing how the directional selectivity of light beams of the light guide is measured in the present invention.

FIG. 23 is a perspective view schematically showing main portion of the surface light source device according to one embodiment of the present invention.

FIG. 24 is a perspective view schematically showing main portion of the surface light source device according to another embodiment of the present invention.

FIGS. 25(a) and 25(b) are partial plan view and a sectional view along 9b-9b of the light reflective sheet of still another form in which a multiplicity of base units comprising concave inclined reflecting surfaces are formed on the surface in the reflective sheet used in the surface light source device of the present invention.

FIG. 26 is a plan view schematically showing a not-preferable arrangement pattern of the protrusions forming the light takeout mechanism provided on the light guide.

FIGS. 27(a) to 27(c) are plan views schematically showing a suitable arrangement pattern of the protrusions forming the light takeout mechanism provided on the light guide.

FIG. 28 is a perspective view schematically showing main portion of the surface light source device according to one embodiment of the present invention.

FIG. 29 is a perspective view schematically showing main portion of the surface light source device according to another embodiment of the present invention.

FIGS. 30(a) to 30(c) are explanatory views showing how light is emitted from the protrusions forming the light takeout mechanism provided on the light guide in the surface light source device of the present invention.

FIG. 31 is a perspective view showing the definition of the depth h and the minimum opening width (W min) for the protrusions forming the light takeout mechanism provided on the light guide in the surface light source device of the present invention.

FIG. 32 is a plan view schematically showing one form of the light takeout mechanism comprising a multiplicity of protrusions formed on a surface of the light guide opposite the light emitting surface in the surface light source device of the present invention.

FIG. 33 is a plan view schematically showing another form of the light takeout mechanism comprising a multiplicity of protrusions formed on a surface of the light guide opposite the light emitting surface in the surface light source device of the present invention.

FIG. 34 are schematic explanatory views showing the spread of light beams emitted from the light source, the state of light beams entering the light guide, and the state of light beams emitted from the light takeout mechanism comprising a multiplicity of protrusions formed on a surface opposite the light emitting surface of the light guide.

FIG. 35 is a explanatory view schematically showing manufacturing steps of a mold for manufacturing the light reflective sheet of the present invention.

FIG. 36 is partial sectional views showing the laminating structure of the light reflective sheet used in the surface light source device according to one embodiment of the present invention.

FIG. 37 is explanatory views schematically showing how the light reflective sheet is arranged warped in the direction of the light guide, and the reverse arrangement thereto.

FIG. 38 is an explanatory view schematically showing a device for manufacturing the light reflective sheet of the present invention.

FIG. 39 is a partial perspective view showing how a multiplicity of base units are transferred on a thermoplastic resin film by use of emboss rolls used in the manufacturing device shown in FIG. 38.

FIG. 40 is a perspective view schematically showing main portion of the most preferable embodiment of the surface light source device of the present invention.

FIG. 41 is an explanatory view showing how bright lines develop in the light guide near the area where the light source is arranged, in the surface light source device.

FIG. 42 is a perspective view schematically showing main portion of one example of the surface light source device which the present inventors proposed before.

FIG. 43 is perspective view schematically showing main portion of another example of the surface light source device which the present inventors proposed before.

FIG. 44 is an explanatory view showing how light beams that have entered the light guide is scattered by the light takeout mechanism in a conventional surface light source device.

FIG. 45 is an explanatory view seen from the light incoming surface of the light guide, showing the locus of light beams in a conventional surface light source device when a light guide having corrugations on the light emitting surface is used as an element of the surface light source device.

FIG. 46 is a sectional view schematically showing one example of a conventional surface light source device.

FIG. 47 is a sectional view schematically showing another example of a conventional light source device.

FIG. 48 is a perspective view schematically showing main portion of one example of the surface light source device which the present inventors proposed before.

FIG. 49 is a sectional view schematically showing main portion of one example of the surface light source device which the present inventors proposed before.

FIG. 50 is a structural explanatory view schematically showing how the diameter of the protrusions provided as the light takeout mechanism on the light guide forming the surface light source shown in FIG. 48 increases as they are apart from the light source.

FIG. 51 is a plan view of the light guide showing how the diameter of the protrusions provided in dots as the light takeout mechanism on the light guide forming the surface light source shown in FIG. 48 increases as they are apart from the light source.

### EMBODIMENTS OF THE INVENTION

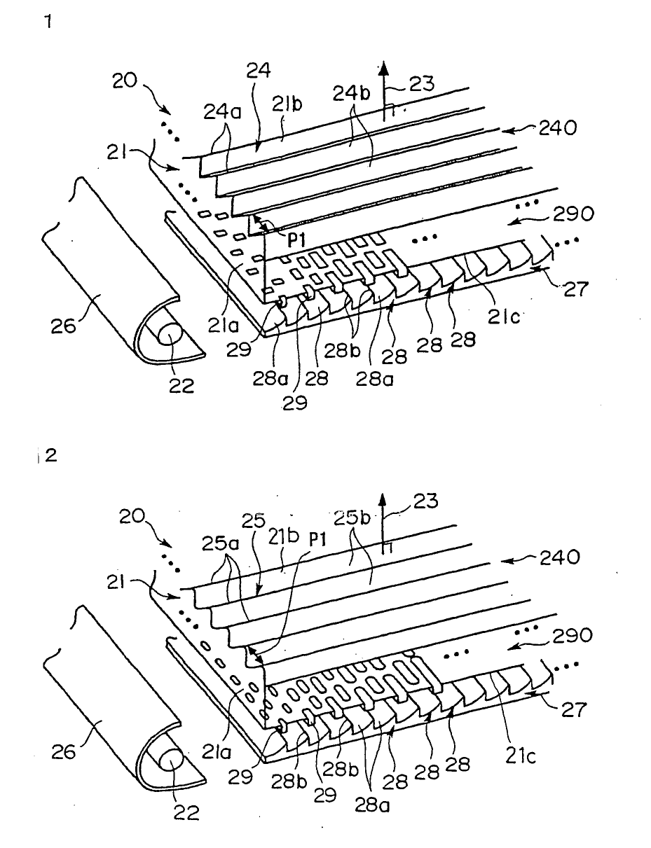

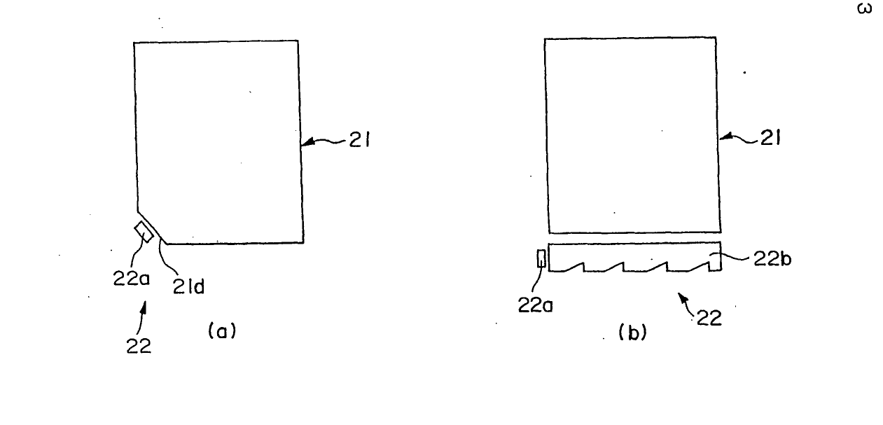

Hereinbelow, the light reflective sheet of the present invention, and its manufacturing method, and a surface light source device and a liquid crystal display device using the light reflective sheet, embodiments shown will be described in more detail. FIGS. 1 and 2 schematically show two embodiments of the surface light source devices according to the present invention.

The surface light source assemblies 20 shown in these figures both include a light guide 21 in the form of a substantially transparent flat board, and a linear light source 22 provided along one side of the light guide 21, which may be, but is not limited to, a fluorescent lamp or an array of LED's. As the linear light source 22, it is preferable to use a cold cathode tube because it is high in light emitting efficiency and is relatively small in size.

Instead of the arrangement of the linear light source shown in FIGS. 1 and 2, a single cold cathode tube may be provided along only one side of the light guide, two cold cathode tubes may be provided along only one side of the light guide, or one or two cold cathode tubes may be provided along either side of the light guide.

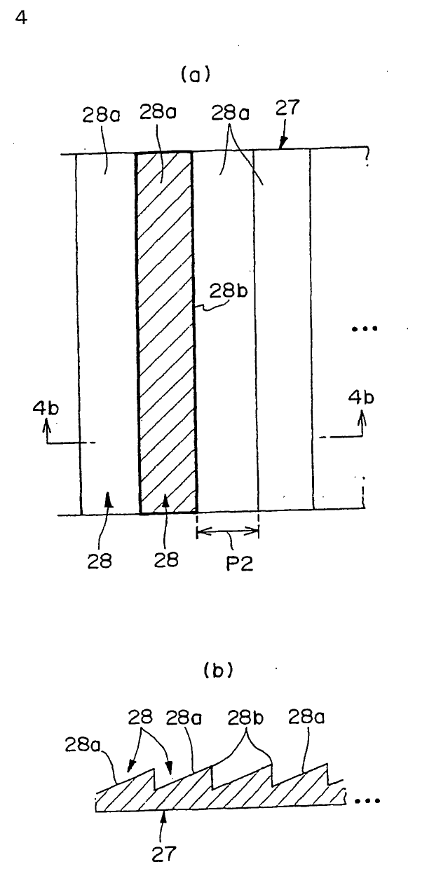

Also, the light source is not limited to a linear light source. For example, the light source may comprise a dot light sources such as an LED as shown in FIG. 3, e.g. in a small surface light source assembly. The light source assembly of FIG. 3(a) comprises a light guide 21 having one corner thereof cut as shown at 21d to form a triangular space as viewed from top, and a dot light source 22a in the form of an LED which is provided in the triangular space. The light source assembly of FIG. 3(b) includes an optical rod 22b provided along one side of the light guide 21, and a dot light source 22a in the form of an LED provided at one end of the optical rod 22b.

At one side of the light guide 21, a lamp reflector 26 is mounted to cover the linear light source 22 such that both light from the linear light source 22 and light reflected by the reflector 26 will enter the light guide 21 through an end face 21a which is the light incoming end face. The lamp reflector 26 may be made of any material that is high in light reflectance, but is preferably made of a metallic plate having an Ag deposit layer or a white plastic film.

The light guide 21 is a square transparent thin board having a thickness of about 2-4 mm. Its top surface (top in FIGS. 1 and 2) is a light-emitting surface 21b through which light leaves the light guide 21. Its bottom surface (bottom in FIGS. 1 and 2) opposite to the light-emitting surface 21b is designated by 21c. In FIGS. 1 and 2, the arrow 23 indicates a direction perpendicular to the light-emitting surface 21b of the light guide 21.

The light guide 21 of the surface light source device 20 of FIG. 1 has on its light-emitting surface 21b a condenser element 240 in the form of an array 24 of triangular prisms having ridges 24a extending substantially parallel to a line perpendicular to the light-incoming surface 21a to condense light efficiently.

For the same purpose, the light guide 21 of the embodiment of FIG. 2 has on its light-emitting surface 21b a condenser element 240 in the form of array-like elements 25′ having a cross-section in the shape of a sine curve of which their ridges 25a extend substantially parallel to a line perpendicular to the light-incoming surface 21a of the light guide 21. The pitch P1 between the triangular prisms 24b forming the array 24 or the pitch P1 between the elements 25b forming the array 25′ are preferably so small as not to be seen by the naked eye.

The condenser element 240 provided on the light emitting surface 21b of the light guide 21 may be an array of prisms, an array of lenticular lenses, an array of microlenses, etc. It must not hinder the transfer of light beams in the light guide 21. Consideration in this regard is especially important for a large surface light source assembly. Specifically, the condenser element 240 preferably have a corrugated shape with ridges extending substantially perpendicular to the side edges 21a of the light guide 21.

At the surface 21c of the light guide 21 opposite to the light-emitting surface 21b, a light reflective sheet 27 is provided.

The light reflective sheet 27 used in the surface light source device of the present invention imparts optical functions such as light condensing and change of angle to illuminating light beams selectively emitted toward the light reflective sheet 27 by the light takeout mechanism 290, which is provided on the light guide 21 and formed with flat surfaces, and serves to impart preferable optical properties as a surface light source.

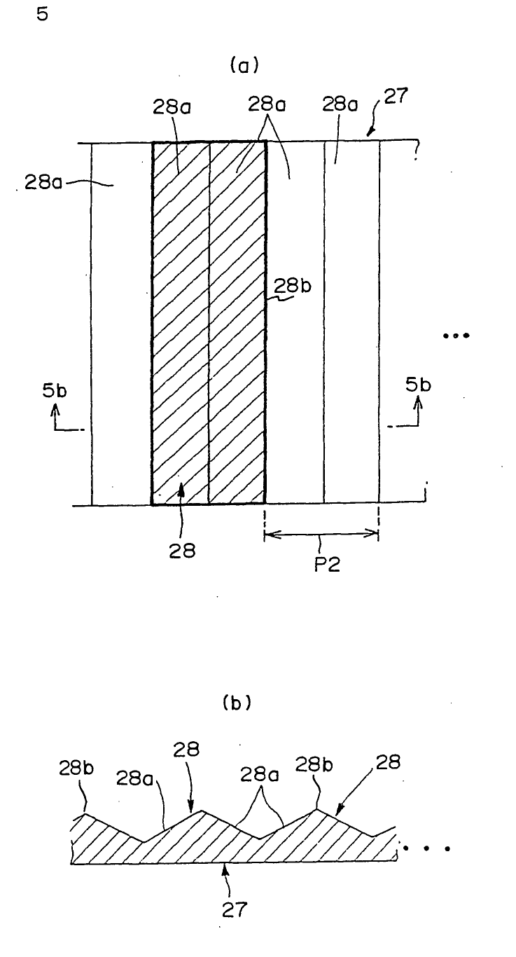

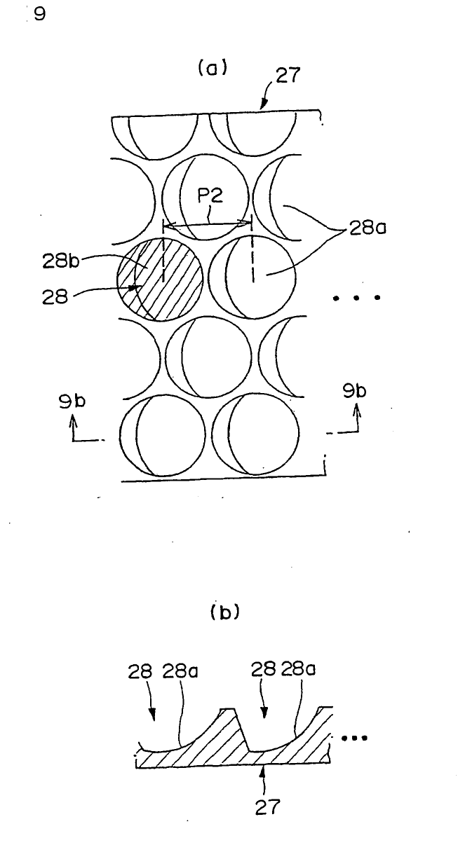

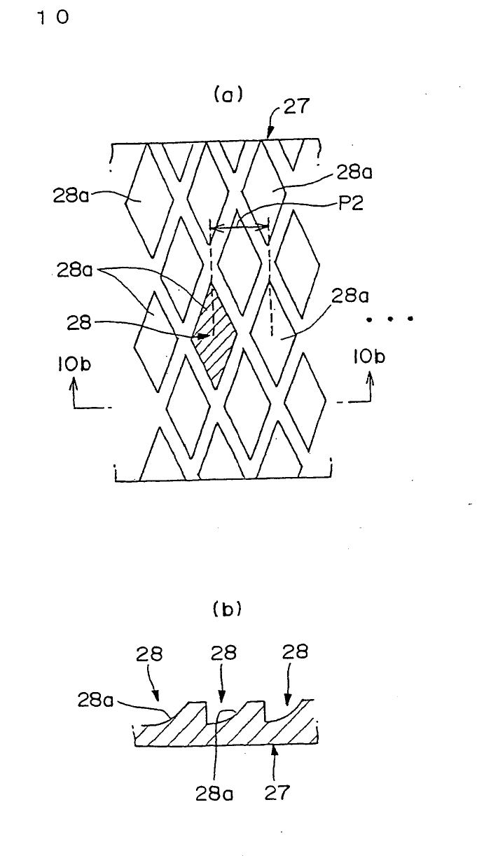

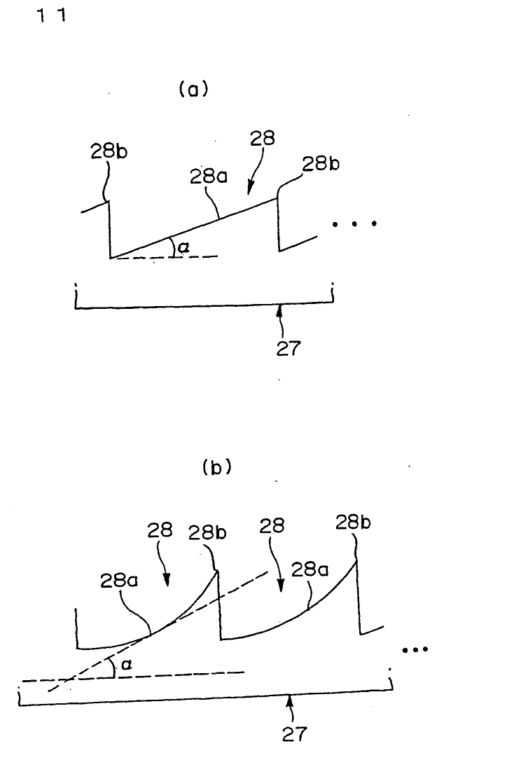

The light reflective sheet 27 comprises a substrate and numerous base units 28 having inclined light reflective surfaces 28a and formed on the substrate at a very small pitch P2. The base units 28 each have an inclined reflective surface 28a (as shown in FIGS. 4-10) analogous or identical in shape.

Each base unit 28 is what is known as a unit cell, which is undivisible without losing analogousness or identicalness. As shown in FIGS. 4-10, the pitch P2 is a minimum length in the base period formed by arranging the base units 28.

The light guide 21 is provided with the light takeout units 290, which selectively directs light introduced into the light guide 21 exclusively toward the reflective sheet 27.

The light takeout units 290 provided for the light guide 21 work as light-emitting elements 29 having directional selectivity and are essentially different from conventional light takeout units which take out light using simple light scattering by rough-surface patterns or ink-print patterns.

More specifically, the rate at which the illuminating light is selectively emitted toward the light reflective sheet 27, as defined using an index (emitting direction selection rate) showing the selectivity of light emitting direction, is preferably 60-100%, more preferably 70-100%, further preferably 75-100%. It has such a structure that light is emitted selectively toward the light reflective sheet 27 so that the illuminating light beams will be exposed to an optical action by the light reflective sheet 27.

The emitting direction selectivity rate is, as described above, a value which shows the ability to emit illuminating light beams selectively toward the light reflective sheet in the form of a numerical value.

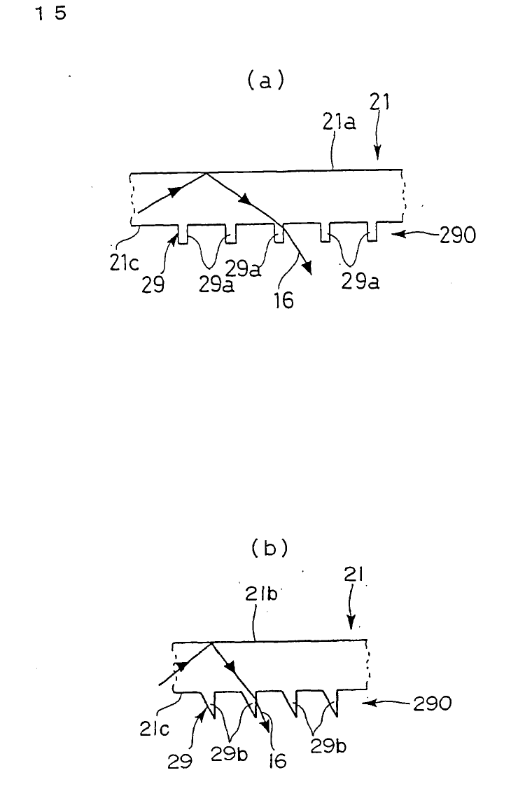

This rate is measured as follows. First, as shown in FIG. 12, the reflective sheet 27 is replaced with a black sheet 30 which completely absorbs light, such as paper planted with fiber. With the light guide 21 set in a normal direction, the emitting angle distribution in a given direction 101 in a plane which is perpendicular to the side end 21a facing the light source 22 and parallel to the normal line 23 is measured by use of a luminance meter.

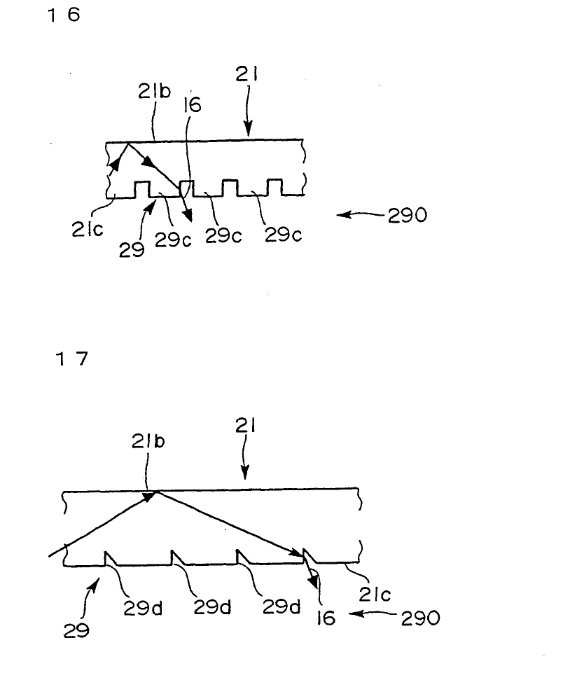

The integrated value La in a graph showing the variation in the luminance thus measured for the light emitting angle (area of the shaded portion in the graph of FIG. 13(a)) is calculated. Then, the light guide 21 is turned over so that the surface 21b (which is supposed to be the light emitting surface) will face the black sheet 30, and the emitting angle distribution in the direction 101 is measured using a luminance meter as shown in FIG. 13(b).

The integrated value Lb of the graph showing the variation in the luminance thus measured for the light emitting angle is determined. The rate Lb/(La+Lb) emitting direction selective rate (that is the rate at which light beams are selectively directed toward the light reflective sheet). In the present invention, the emitting direction selective rate is measured near the center of the light emitting surface 21b.

The thus obtained emitting direction selective rate is, as described above, preferably 60-100%, more preferably 70-100%, further preferably 75-100%. By selectively directing light toward the reflective sheet 27, it is possible to effectively utilize the effects of the base units 28 formed on the surface of the reflective sheet 27. Their light condensing function and angle changing function help to obtain good optical properties.

The selectivity of light beam emitting direction from the light guide 21 can also be measured by the following method. A black sheet 30 that completely absorbs light (such as paper planted with fiber) is arranged at a position where the reflective sheet is usually disposed, and as shown in FIG. 22, with the light guide 21 set in its normal position, light is turned on in an integrating sphere 22′ to measure the total amount Σa of light beams emitted from the light guide 21 through its light emitting surface.

Then, with the light guide 21 turned over (so that the surface normally facing the reflective sheet will face the light emitting surface), and light is turned on in the integrating sphere 22′ to measure the total amount Σb of light beams emitted from the light guide 21 through its surface opposite to the light emitting surface. The rate of light beams (%) selectively directed toward the reflective sheet is given by Σb/(Σa+Σb)×100. This value is preferably 65% or over, more preferably 70% or over, further preferably 75% or over.

In such an optical system, the light from the light guide 21 has to be directed toward the reflective sheet 27 at as high a rate as possible. For this purpose, on the surface opposite to the light emitting surface 21b of the light guide 21, a light takeout mechanism 290 is provided which comprises numerous directional light emitting elements 29 having flat surfaces which do not cause undue light scattering.

Namely, the light takeout mechanism 290 serve to direct the light from the light guide 21 selectively toward the reflective sheet 27. The substantially identically shaped base units 28 provided on the reflective sheet 27 and having inclined surfaces 28 condense the light beams and change their angle, thereby controlling the characteristics of the light beams.

In the surface light source assembly of the present invention, unlike ordinary side-light type surface light source assemblies, directional light emitting elements 29 having flat surfaces, which are provided on the surface 21c of the light guide 21 opposite to the light emitting surface 21b, direct most of the light beams selectively toward the reflective sheet 27. The light beams are then reflected by the reflective sheet 27 and emitted toward the front of the device.

By adopting such an optical path, if the condenser element 240 is provided on the light emitting surface 21b of the light guide 21, such as triangular prism array 24 or lenticular lens array 25, the light guide 21 itself can perform the optical function as a lens array sheet. Thus, it has far superior condensing properties compared with conventional surface light source assemblies in which the light guide is simply provided with condenser elements.

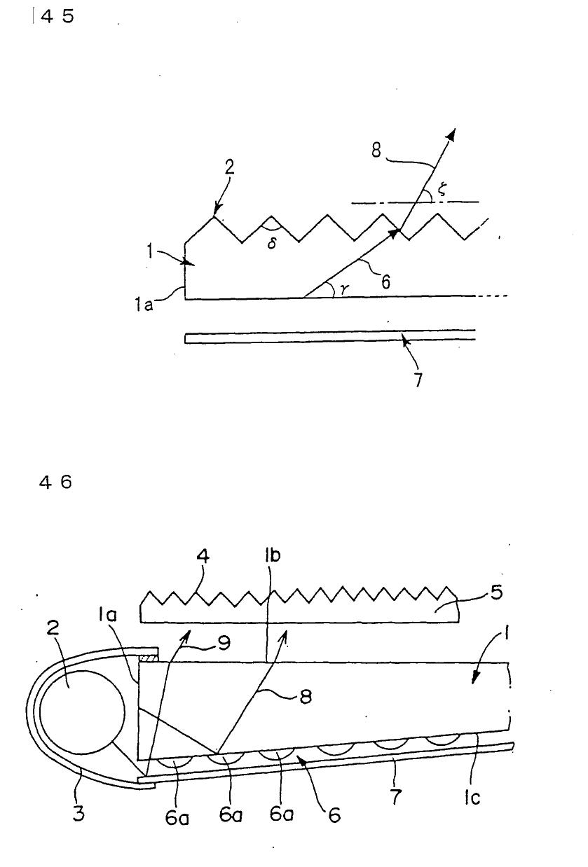

Specifically, as shown in FIGS. 42 and 43, conventional sidelight type surface light source assemblies also have an optical element such as a triangular prism array 2 or a lenticular lens array 3 provided on the light emitting surface 1b of the light guide 1 to improve the light condensing capacity. But its function is not fully utilized. We will explain why.

As shown in FIGS. 42 and 43 the conventional light guides, in which triangular prisms or lenticular lenses are formed, are provided on the light emitting surface 1b to improve the light condensing property. But simply forming such condensing elements for the light guide is insufficient in the optical efficiency.

In such conventional surface light source devices, a pattern comprising a rough surface or rough-surface portions 4a, 4b, 4c . . . or a dot pattern formed by light scattering ink is formed as a light takeout mechanism 4 to take out light utilizing light scattering phenomenon that occurs at the rough surface portions.

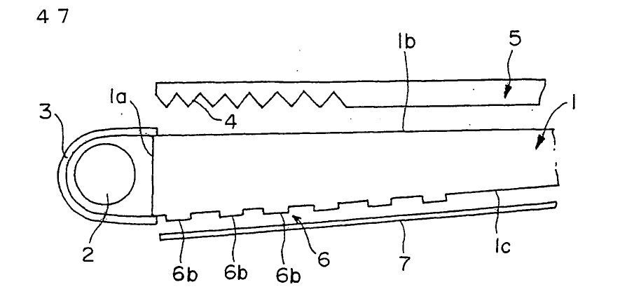

In such a simple arrangement in which light scattering phenomenon is used for a light takeout mechanism 4, as shown in FIG. 44, scattered light beams are random in outgoing directions. Thus, light beams scattered out of the light guide 1 and light beams scattered in the light guide 1 coexist, so that illuminating light beams 5 directed toward the reflective sheet 7 and illuminating light beams 6 directed directly toward the light emitting surface 1b of the light guide 1 coexist.

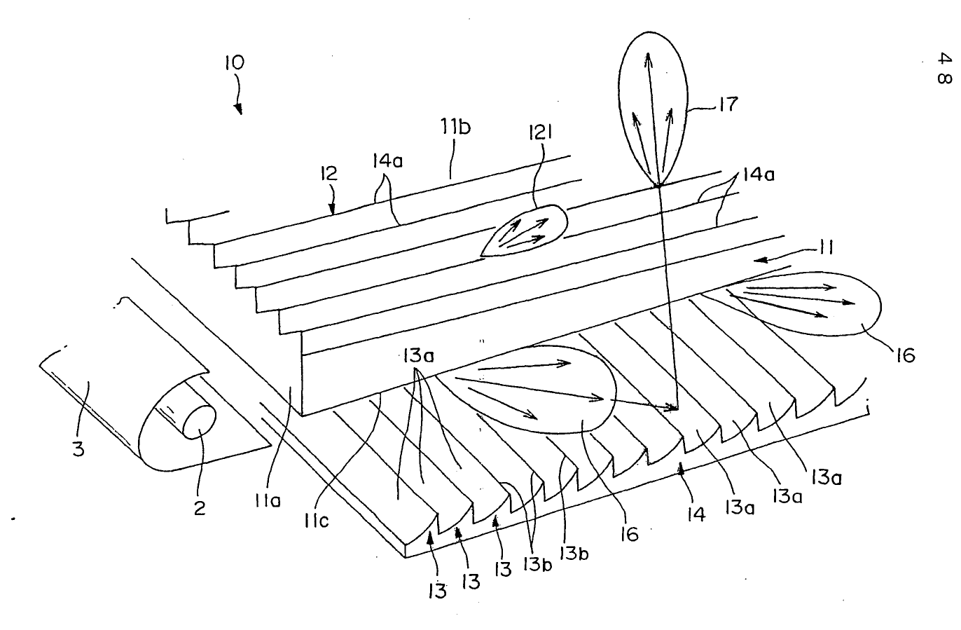

Light condensing effects to which the light beams directed directly toward the light emitting surface 1b of the light guide 1 as shown in FIG. 45 are subjected by the condensing elements such as an array 2 of triangular prisms formed on the light emitting surface 1b of the light guide 1 will be considered from the point of view of geometrical optics. The outgoing angle ζ of illuminating light beams 8 emitted from the light emitting surface 1b after having been condensed by the triangular prism array 2 is given by the following formula (1):

$$ζ = arcsin ( n \cdot sin ( γ - \frac{δ}{2} ) ) + \frac{δ}{2}$$

wherein n is the refraction factor of the light guide, γ is the light emitting angle and δ is the vertex angle of triangular prism array 2.

Since the rate of light beams 6 directed directly toward the triangular prism array 2 is relatively high, the light beams pass through the air-to-light guide interface only once. Thus, only the condensing effects expressed by the formula 1 can be expected, so that the effect of the triangular prism array 2 cannot be fully achieved.

In contrast, with the surface light source assembly according to the present invention, most of the illuminating light beams are directed toward the reflective sheet 27 by the directional light emitting elements 29 having flat surfaces. Thus, as shown in FIG. 14, a major portion of the illuminating light beams 16 are reflected by the light reflective sheet 27, and then the light beams pass through the air-to-light guide interface twice after having been reflected by the reflective sheet 27. The outgoing angle ζ of the illuminating light beams is thus given by the following formula 2:

$${ζ}_{a} = arcsin ( n \cdot sin ( \frac{π}{2} - arcsin ( \frac{1}{n} \cdot sin ( \frac{π}{2} - γ ) ) - \frac{δ}{2} ) ) + \frac{δ}{2}$$

Thus, high refractory effects are achieved.

That is, the light guide 21 itself functions as a prism sheet. Unlike conventional surface light source devices in which is used a light guide 1 with a light takeout mechanism 4 such as rough surfaces and simply with a prism array 2, from a geometrical optical viewpoint, it is possible to achieve high condensing property.

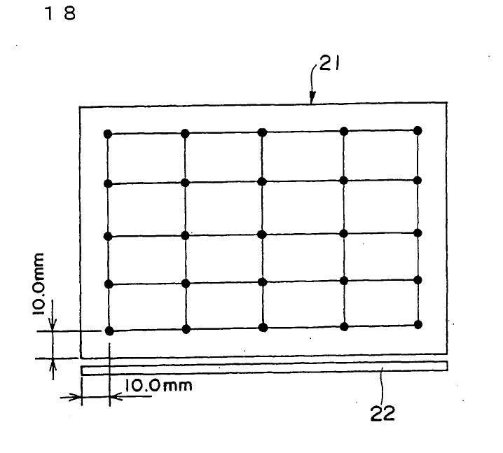

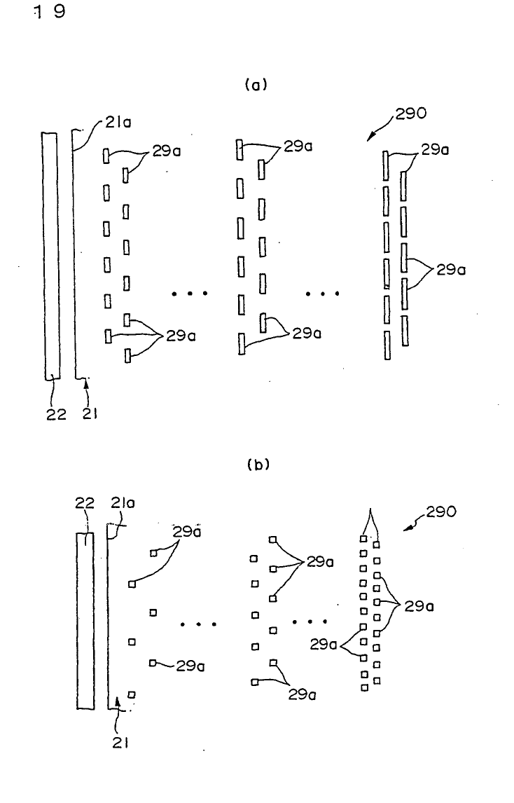

In order to achieve an optical path which is prerequisite in the present invention, i.e. an optical path in which light beams are selectively directed toward the reflective sheet 27, changed in direction by the reflective sheet 27, and again pass through the light guide 21, as a mechanism 290 for taking out light beams transmitted through the light guide 21, as shown in FIGS. 15A, 15B, 16 and 17, it is necessary to provide elements formed with flat surfaces and having a sectional shape which makes it possible to selectively emit light toward the reflective sheet 27, that is, the directional light emitting elements 29 on the surface 21c, which is opposite to the light emitting surface 21b.

The directional emitting elements 29 will be described in more detail. In order to selectively direct the light beams toward the reflective sheet 27, the elements 29 have to be formed with smooth surfaces at least. Even small amount of rough surfaces will cause light to scatter in random directions, thus making it difficult to selectively control the light emitting direction.

Specifically, the smooth surface forming the directional light emitting elements 29 should have an arithmetic average roughness Ra defined under JIS-B0601 of preferably 0.01-10 μm, more preferably 0.02-4 μm, further preferably 0.05-2 μm. Care must be taken that the light beams entering into the directional light emitting elements 29 will not be scattered by rough surface, thus impairing the function of selectively directing illuminating light toward the reflective sheet.

The directional light emitting elements 29 are usually extremely finely formed to prevent their pattern from appearing on the display screen. Thus, if the sampling area in which the arithmetic average roughness is measured is too large, the effect of shape of the light emitting element 29 may reflect on the measured value, thus making accurate measurement difficult. The sampling area must therefore be sufficiently minute (compared with the size of each directional light emitting element 29), specifically about 50 square micrometers to determine the smoothness of the surface of the directional light emitting element.

Specifically, the smoothness and shape of the directional light emitting elements 29 should preferably be adjusted such that of the total light beams emitted from the light guide 21 through the directional light emitting elements 29, preferably 65% or over, more preferably 70% or over, further preferably 75% or over of the light beams will be directed toward the reflective sheet 27.

As described above, the effect of first emitting illuminating light beams intensively toward the reflective sheet 27 is most remarkable if the condensing elements 240 such as an array of prisms are formed on the light emitting surface 21a of the light guide 21. This is because the light beams pass optical paths 16, 31 and 32 as shown in FIG. 14, so that the light guide itself functions as a prism sheet. These paths are essentially different from the optical path 8 in FIG. 45 used in a conventional surface light source assembly in which a prism is simply formed on the light guide, so that they can achieve extremely superior light condensing property.

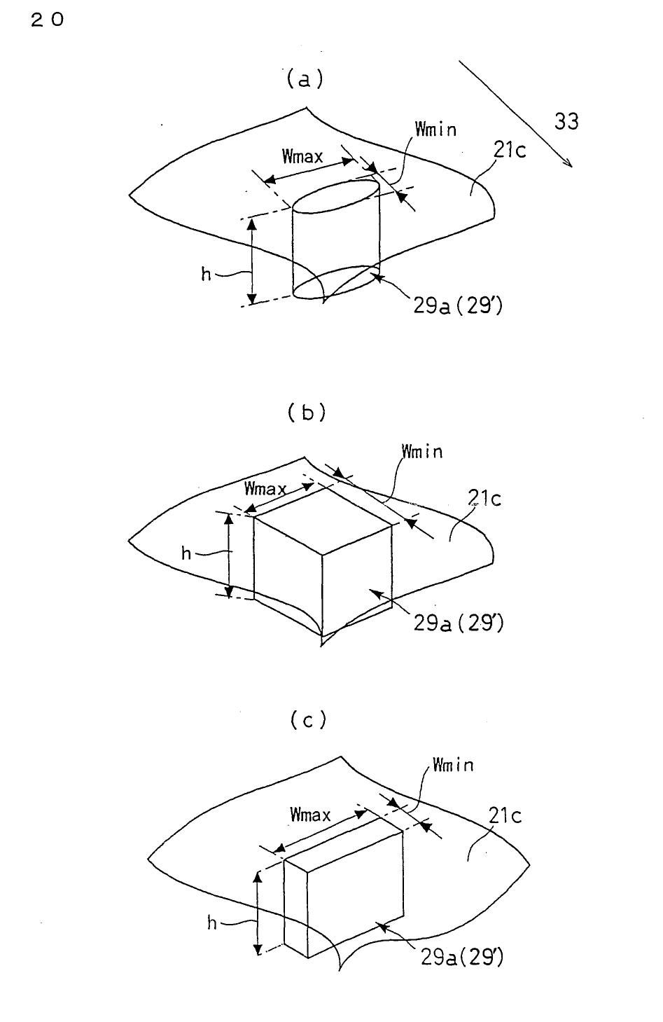

Various structures of the light takeout mechanism 290 are feasible for keeping the light emission selective rate preferably at 60% or over and directing the illuminating light exclusively toward the reflective sheet 27. For example, it may comprise recesses as shown in FIGS. 16 and 17. But the most preferable is a light takeout mechanism 290 comprising a plurality of protrusions 29a having smooth surfaces and formed on the surface 21c opposite the light emitting surface 21b (i.e. the surface facing the light emitting sheet) as shown in FIGS. 1 and 2.

Various surface shape designs shown in FIGS. 15-17 can also direct major part of the light beams emitted from the light guide 21 toward the reflective sheet 27. Specifically, the light takeout mechanism 290 shown in FIG. 15 comprising numerous protrusions 29b having a triangular section and formed on the surface of the light guide 21 facing the reflective sheet 27 in a predetermined pattern.

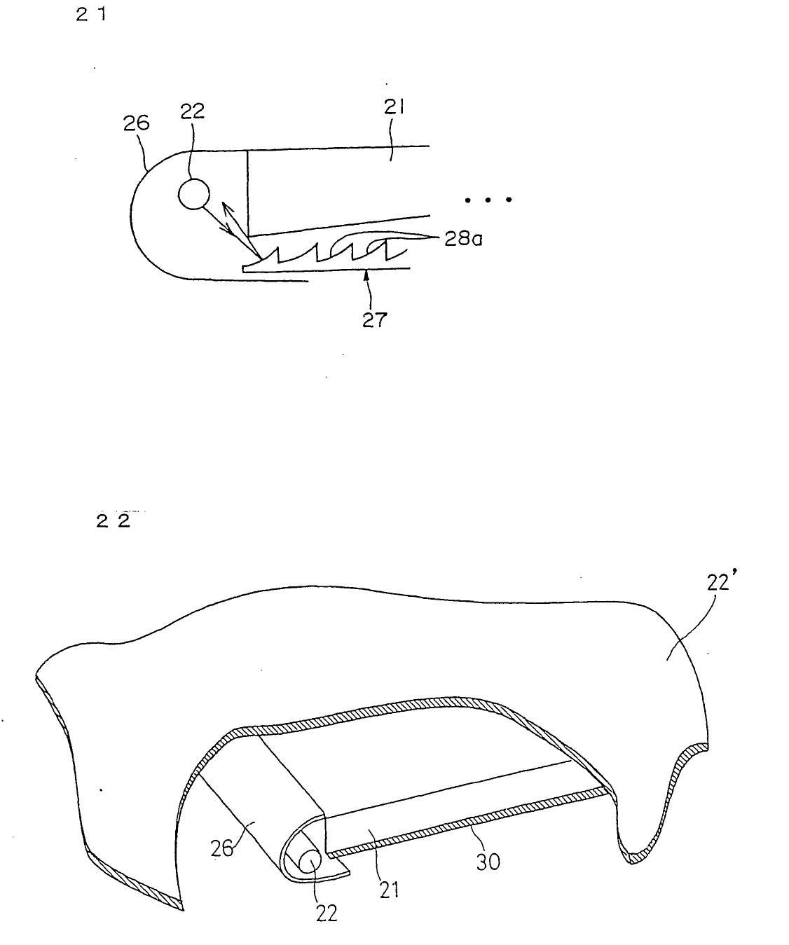

The light takeout mechanism of FIG. 16 comprises recesses formed in the surface 21c of the light guide 21 facing the reflective sheet 27, thereby forming projections 29c to provide a light takeout mechanism 290. The light takeout mechanism of FIG. 18 comprises grooves 29d of V-shape section formed in the surface 21c of the light guide 21 facing the reflected sheet 27 at predetermined intervals.

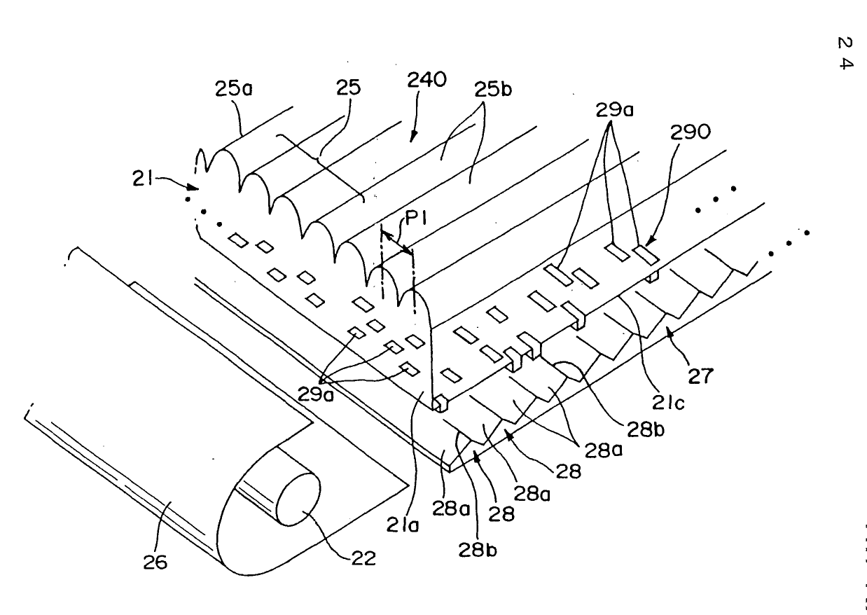

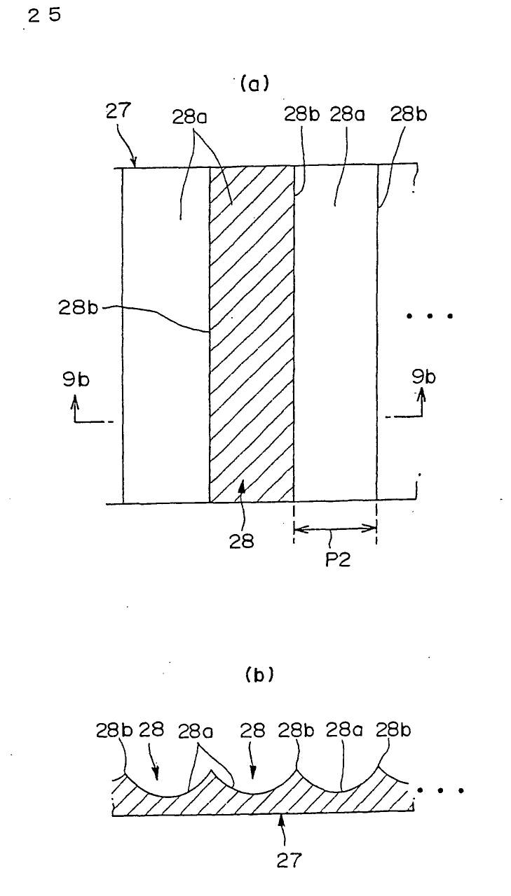

The directional light emitting elements 29 are preferably in the form of protrusions having a smooth surface. That is, as shown in FIG. 20, if such protrusions having a smooth surface protruding from the surface 21c of the light guide 21 have a large depth h compared with the opening width W, it is possible to increase light beams 16 which take a light path as shown in FIG. 15(a) and easily direct the illuminating light selectively toward the reflective sheet 27. Further, after such protrusions have been transferred on the light guide 21 in forming the light guide, the light guide can be easily taken out of the mold. Thus, productivity is high.

Also, if the elements 29 are in the form of convex protrusions, a mold for forming such protrusions can be easily manufactured. By combining photolithography using a dry film resist with etching or electrocasting, it is possible to relatively easily obtain a pattern having a desired protrusion structure.

As for such protrusions, the ratio h/W min of their depth h to the minimum opening width W min is preferably 0.5 or over, more preferably 0.6 or over, further preferably 0.7 or over. By so setting the ratio, most of the light beams entering the protrusions are selectively directed toward the reflective sheet. With this arrangement, most of light beams entering the protrusions are directed selectively toward the reflective sheet. The depths h and the minimum opening widths W min of such protrusions are defined as shown in FIG. 20.

Further, in order for light beams coming into the protrusions to be directed toward the reflective sheet 27, the ratio h/W min of the depth h of the protrusions to their maximum opening width W max is preferably 0.3 or over, more preferably 0.4 or over, further preferably 0.5 or over. The maximum opening width W max is defined as shown in FIG. 20.

In order to maintain constant the illuminating intensity over the entire surface, the pattern of the protrusions should be adjusted such that the farther from the light source 22, the higher light takeout efficiency. For example, the farther from the light source, the protrusions may have the greater opening areas, or all the protrusions have the same opening area but the farther from the light source, the more densely they may be arranged. With this arrangement, the light emitting amount can be kept constant irrespective of the distance from the light source.

The arrangement in which the opening area of the protrusions is increasing is easier to adjust. In the present invention, the light takeout mechanism 290 in the form of the protrusions, has to selectively direct the light passing through the light guide toward the reflective sheet 27 only. Thus, the ratio of the depth h to the minimum opening width W min is preferably kept at a high value.

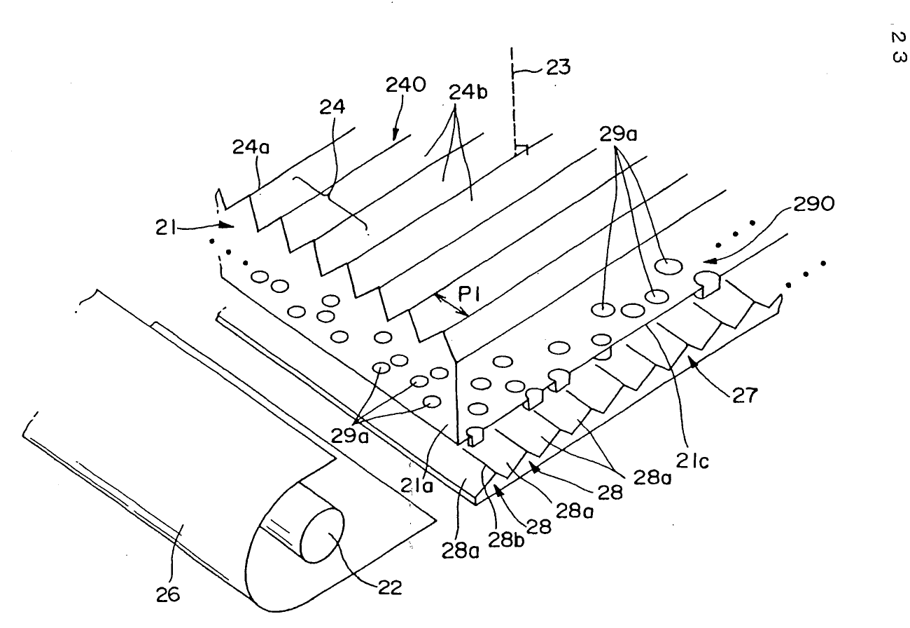

Thus, if the opening area of the protrusions is simply increased, the ratio h/W min may be out of the preferable range at points far from the light source 22. Thus, a pattern is the most preferable in which the opening area of the protrusions is increased while keeping constant the ratio h/W min. Specifically, as shown in FIG. 19(a), the protrusions are most preferably patterned such that the farther from the light source 22, the larger opening the protrusions have in one axial direction.

As for the sectional shape of the protrusions and recesses 29′ forming the light takeout mechanism 290 in the surface light source device 20, in order to make the light takeout mechanism 290 provided for the light guide 21 superior in controllability of light emitting direction, the surfaces of the protrusions or recesses 29′ forming the light takeout mechanism 290 have to be as smooth as possible, as described above.

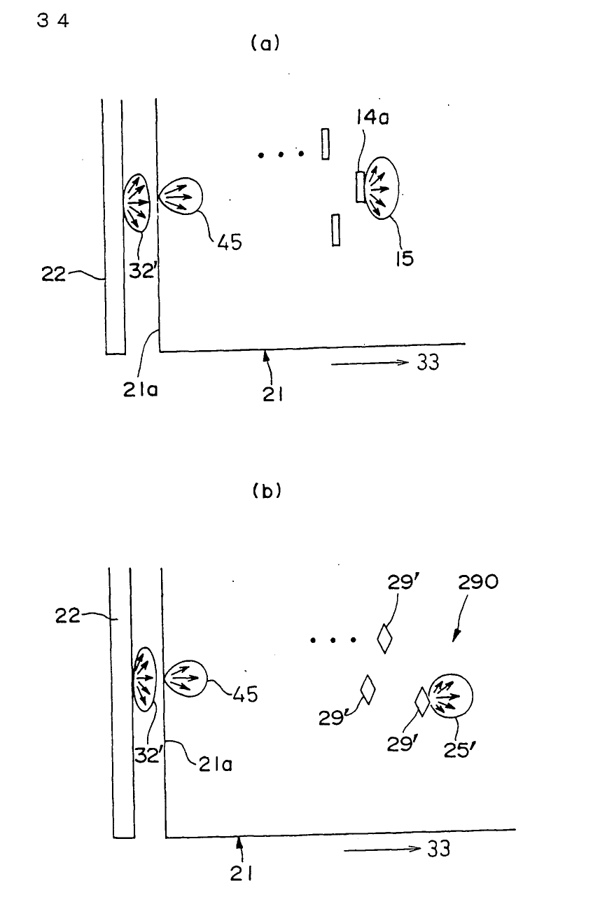

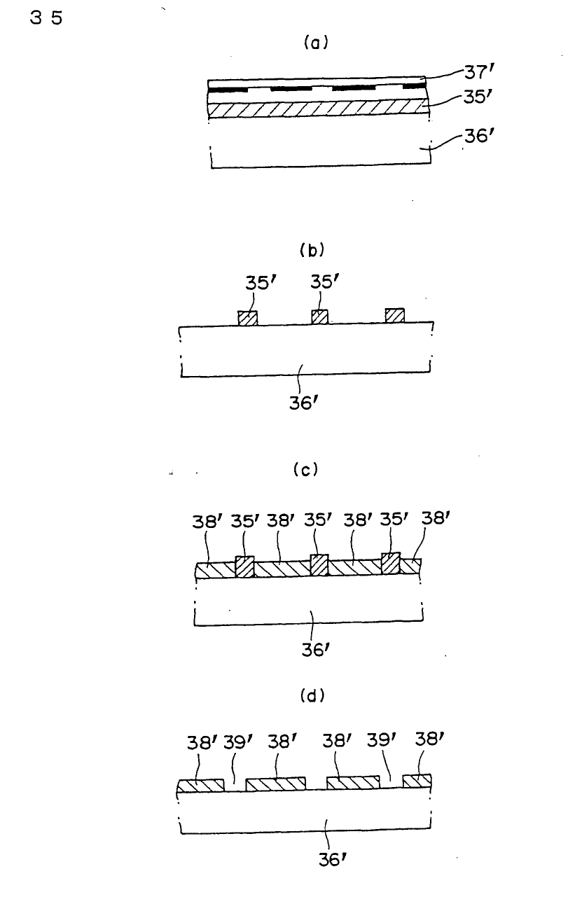

If the surfaces of the protrusions or recesses 29′ forming the light takeout mechanism are rough, as shown in FIG. 30(a), light scattering will be induced by the rough surfaces, so that directionality of light beams would be lost. If the protrusions or recesses 29′ have smooth surfaces, according to the geometric optics as shown in FIG. 30(b), it is possible to cause light to emit selectively in a predetermined direction only.

Further, in order to take out light efficiently in a predetermined direction, the depth h of the protrusions or recesses 29′ is preferably as large as possible compared to the minimum opening width W min of the protrusions or recesses 29′ as defined in FIG. 31. In view of workability, the ratio h/W min is preferably 0.5-2.5, more preferably 0.6-1.5, further preferably 0.7-1.3. The depth h of the protrusions or recesses 29′ means the height of the protrusions or recesses 29′ as measured from the surface of the light guide 21 on which the protrusions or recesses 29′ are formed as shown in FIGS. 30(b), 31(a) and 20(a). The minimum opening width W min is the minimum width of the protrusions or recesses 29′ as seen from above as shown in FIG. 31(b).

Further, as shown in FIG. 20(a), the larger the ratio of the depth h to the effective opening width Weff as seen in section in the direction 33 in which illuminating light beams in the light guide 21 mainly conduct (that is, direction perpendicular to the side 21a of the light guide along which the light source is provided), the more easily the illuminating light beams can be directed in a predetermined direction. The ratio h/Weff is preferably as large as possible within such a range that the formability is not impaired. Specifically, this ratio is preferably 0.5-2.5, more preferably 0.6-1.5, further preferably 0.7-1.3.

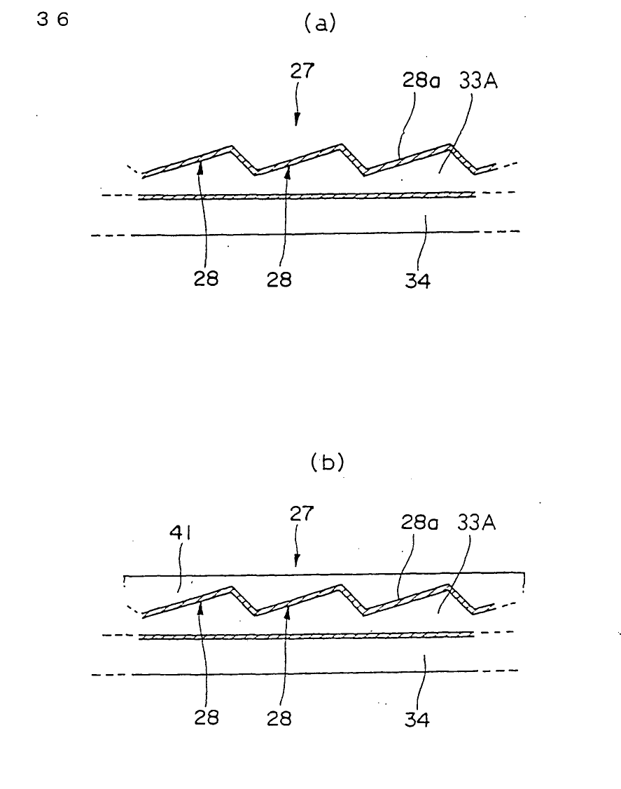

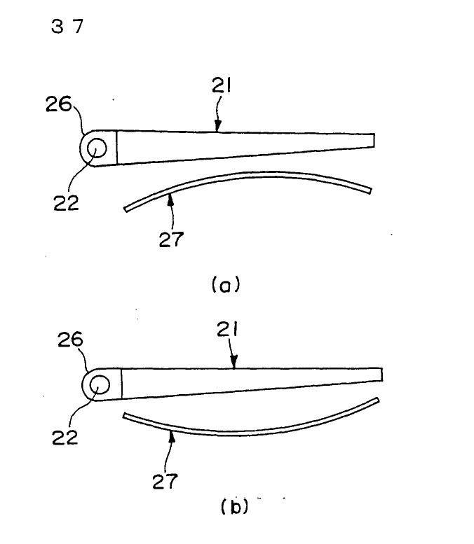

As shown in FIG. 20(a), the effective opening width Weff is the width of the protrusions in the direction 33 perpendicular to the side of the light guide 21 along which the light source is provided, as seen in section in the thickness direction of the light guide 21. By forming such protrusions or recesses 29′ which have smooth surfaces and are relatively deep (high) compared with the opening width, the illuminating light beams are selectively guided toward the reflective sheet 27. According to this invention, in order to further increase the light condensing property, as shown in FIGS. 32(a)32(c) and 33(a)-33(c), the protrusions or recesses 29′ protrude in the direction in which light mainly proceeds, as seen from right over the light emitting surface 21b′ of the light guide 21.

By selecting such a shape, the protrusions or recesses function as lenses and condense the light beams emitting from the light guide 21. Thus, by combining them with the reflective sheet 27, which has an array of inclined reflective surfaces, it is possible to increase the luminance in the forward direction.

In this regard, explaining with reference to FIG. 34, which is seen from right over the light emitting surface 21b′ of the light guide 21, emitting angle distribution of light beams from a fluorescent lamp as a typical light source is an isotropic distribution in which the light intensity varies little with the direction, as shown by numerals 32′ in FIG. 34(a). But light beams coming into the light guide 21 through its light incoming surface 21a are converged in angle distribution as shown by numeral 45 under the Snell's law.

With the conventional light takeout mechanism 14 shown in FIG. 34(a), the converged light beams turn to light beams of which the emitting angle distribution diverges again as shown at 15. Even if they are directed in a forward direction by the inclined surfaces 28a of the reflective sheet 27, they cannot be sufficiently condensed.

In contrast, with the light takeout mechanism 290 comprising the protrusions or recesses 29′ according to this invention, its portion that practically contributes to the takeout of light is convex with respect to the light incoming surface 21a of the light guide 21 as seen from right over the light emitting surface 21b′, so that when light is emitted from the light guide 21 as shown in FIG. 34(b), they function as lenses. Thus, the light beams 25′ emitted from the light guide 21 can be sufficiently condensed. Thus, by directing the emitted light beams in the forward direction with the reflective sheet 27, it is possible to emit light beams having high luminance in the forward direction.

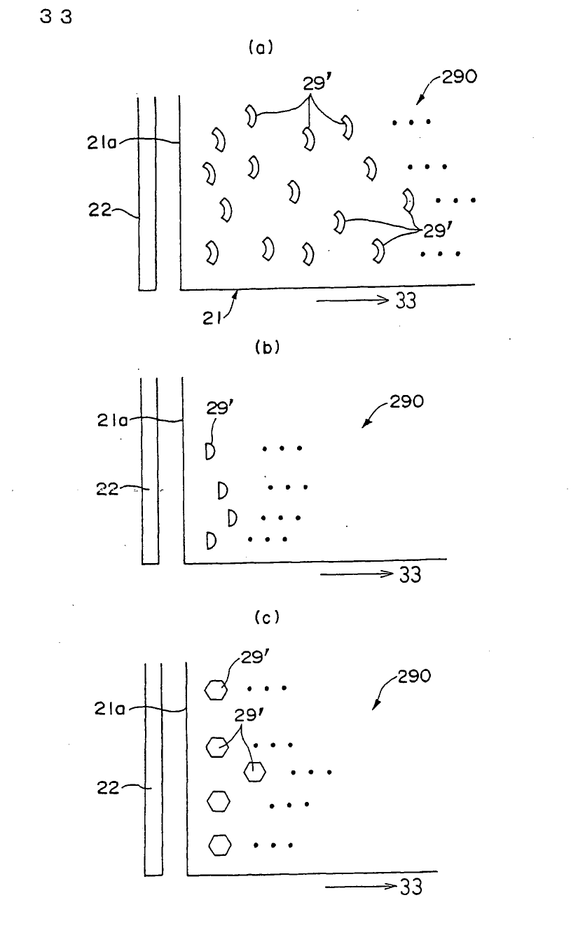

Preferably, as shown in FIG. 28 or 29, the light takeout mechanism 290 comprises protrusions 29A provided on the surface opposite the light emitting surface 21b′ of the light guide 21 and having smooth surfaces. As seen from right over the light emitting surface 21b′, as shown in FIGS. 32(a) to 32(c), the protrusions 29A may have triangular, square, or oval dot pattern.

The protruding amount (height) of the protrusions 29A are preferably 2-300 μm, more preferably 5-200 μm, further preferably 10-100 μm. In order to restrict unfavorable unevenness due to interference such as Moire fringe, the protrusions 29A are preferably arranged in a random fashion.

Because in the present invention the protrusions 29A have a large height compared to the effective opening width Weff and light beams passing through the light guide 21 are taken out through sides of the protrusions 29A toward a predetermined direction as shown in FIG. 30(b), the protrusions 29A which have smooth surfaces, may have such a sectional shape that the corner facing the light source is cut to form an inclined surface 34′ extending along light beams passing through the light guide 21 as shown in FIG. 30(c).

But the light takeout mechanism is not particularly limited so long as it can intensively emit the illuminating light beams toward the reflective sheet while keeping the emitting direction selectivity rate at 60% or over. For example, it may be scattering members provided in the light guide 21 and having forward scattering property with respect to a specific direction, or diffraction optical elements such as hologram elements or surface relief elements, provided on the surface of the light guide 21.

In order to obtain sufficient illuminating light beams as a backlight source for a large-sized liquid crystal display device, it has been found out that simply setting an emitting direction selectivity rate within the abovementioned range is not sufficient. In the above-described type optical system, even if sufficiently practical evenness in luminance is obtained when viewed from front, the unevenness in luminance may be extremely poor when viewed obliquely.

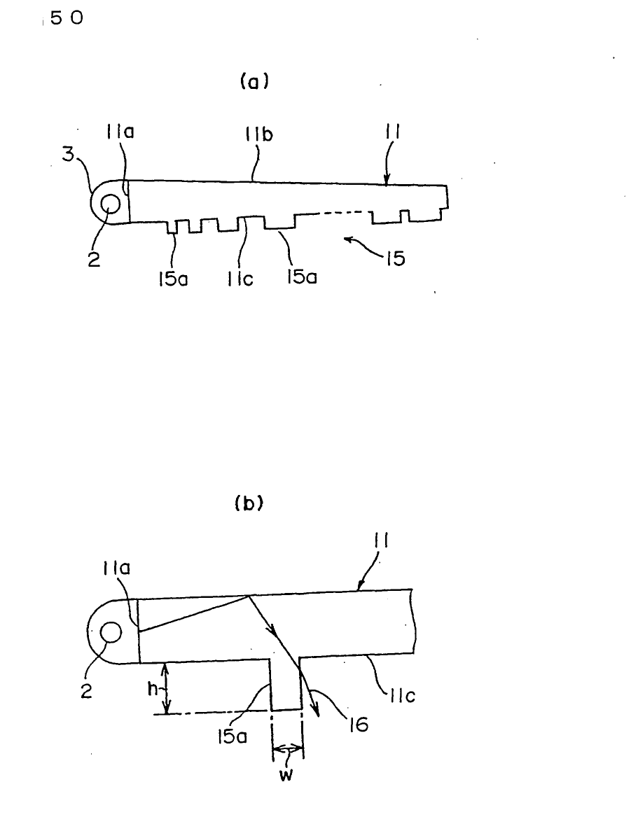

This is because light beam components are present which directly emit obliquely forwardly from the light emitting surface 11b instead of emitting toward the reflective sheet 14 as shown in FIG. 48 as light beam components 121. That is, if the amount of light beam components vary according to the area where they emit, as shown in FIG. 48, the angle distribution characteristics of the entire surface light source assembly will vary with area. Thus, even if sufficiently uniform illumination intensity is obtained when the light emitting area is seen from front, evenness in luminance may be poor when the surface light source assembly is seen obliquely. This makes the device impractical.

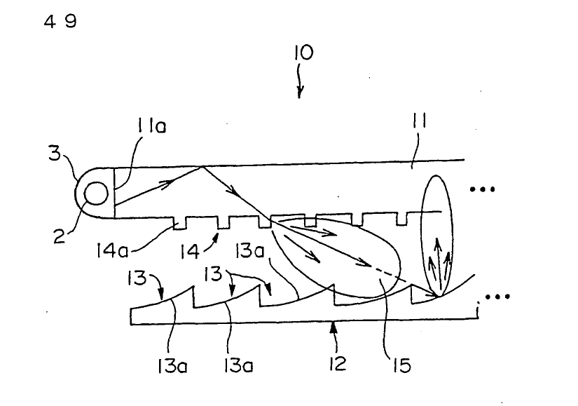

This is a problem which inevitably occurs with an optical system in which illuminating light beams are first intensively emitted toward the reflective sheet 27, and conventional surface light source assemblies using a light takeout mechanism comprising simple rough surfaces or ink (as shown by numeral 6 in FIGS. 46 and 47) had no such problem.

In the present invention, the light takeout mechanism 290 of the light guide 21 is designed such that the emitting direction selectivity rate will be substantially constant as measured at any point of the light emitting surface 21b of the light guide 21. Specifically, the emitting direction selectivity rate measured at any point in the light emitting surface 21b is in the range of ±30% or less, preferably ±25% or less, more preferably ±20% or less in terms of the average of the measured values.

The points in the light emitting surface 21b mean 5 to 50 measuring points sampled uniformly over the entire light emitting surface 21b. Typically, as shown in FIG. 18, this rate is measured at 25 points into which the light emitting surface 21b is uniformly divided. By use of the values measured at these points, the above-described rate is determined.

As an embodiment which meets these requirements and are practical, the light takeout mechanism 290 shown in FIG. 1 comprise a plurality of protrusions 29a each having a protruding amount of 300 μm or less and having smooth surfaces and arranged such that as they are farther from the light source 22, their lengths vary only in a direction substantially parallel to the side 21a of the light guide 21 along which the light source 22 is provided, as shown in FIG. 19(a).

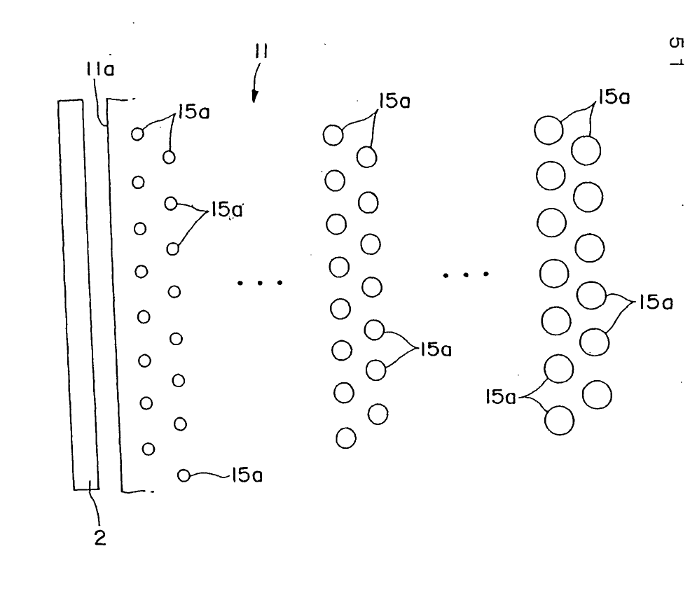

Specifically, in a light guide 21 of which the light takeout mechanism 290 comprises protrusions 29a, the rate of light beams emitting toward the reflective sheet 27 is mainly determined, as shown in FIGS. 20(a) and 20(b), by the ratio of the depth h of the protrusions 29a to the width Weff (effective opening width) of the protrusions 29a as seen in the section perpendicular to the side 21a along which the light source 22 is arranged. That is, the larger the depth h relative to the effective opening width Weff, as shown by the beam path 16 in FIG. 50(b), the greater the amount of light beams emitted toward the reflective sheet 27. Thus, the amount of light beams that are not directed toward the reflective sheet due to total reflection at the bottoms of the protrusions decreases as seen by beam paths 121 in FIG. 48.

Thus, as shown in FIGS. 50(a) and 51, with a simple pattern in which the dot diameter increases as the dots are farther from the light source as is often seen in conventional light guides, the ratio of the depth h to the effective opening width Weff of the protrusions changes as they are farther from the light source. Thus, the rates of light beams emitted toward the reflective sheet widely differ between an area near the light source and an area far from the light source. As a result, the angle distribution characteristics of the emitted light differs widely according to places. This has a bad influence on the appearance.

Thus, in order to improve the appearance of the surface light source assembly of the present invention, the pattern of the protrusions 29a should be determined that the ratio of the depth h of the protrusions 29a to the effective opening width Weff as viewed in the direction perpendicular to the side 21a of the light guide along which the light source 22 is provided (direction shown by the arrow 33 in FIG. 20) will be constant irrespective of the distance from the light source 22. For this purpose, the protrusions preferably have such a pattern that their lengths will vary only in one axial direction, i.e. in the direction substantially parallel to the side 21a of the light guide 21 along which the light source 22 is provided, as shown in FIG. 19(a).

Also, for the same purpose, as shown in FIG. 19(c) the protrusions 29a may be arranged such that their distribution density or number increases as they are farther from the light source 22. Such a pattern, too, is preferable in this invention because it is possible to keep the ratio h/Weff constant.

Further, the surfaces of the protrusions 29a are preferably as smooth as possible to prevent unnecessary light scattering so that emitted light can be directed toward the reflective sheet 27. Specifically, the surfaces of the protrusions 29a have an arithmetic average surface roughness Ra defined under JIS B0601 of preferably 0.01-10 μm, more preferably 0.02-4 μm, further preferably 0.05-2 μm. The surface roughness of the protrusions 29a has to be measured in a sufficiently small sampling area (for example 50 μm²) relative to the size of the protrusions 29a.

In this type of optical system, when the surface light source assembly is turned on, ugly unevenness presumably resulting from light interference such as a moire pattern or a pattern like a Newton ring tends to develop, making it difficult to obtain the illuminating light of sufficient quality as a backlight for a large-sized liquid crystal display device.

That is, if trials are made to manufacture a large-sized backlight module using this optical system, ring strips tend to appear or bright and dark thin stripes tend to appear on the entire light emitting surface. Such a backlight is practically useless.

As a result of ardent, repeated studies about the cause of such problems and measures against them, it has been confirmed that the cause is that a large number of substantially identical and/or substantially analogous base units having inclined light reflecting surfaces, which are not different from conventional ones, were used for the light reflective sheet,

It has been found that such unevenness develops if an unintended interference is established between the arrangement of the light takeout mechanism and that of the base units comprising inclined surfaces provided on the light reflective sheet.

That is, because the light takeout mechanism 290 of the light guide 21 and the base units 28 of the reflective sheet 27 are extremely close to each other and in this optical system, illuminating light is first directed exclusively toward the reflective sheet 27, compared to conventional devices, optical interferences such as Newton rings tend to appear.

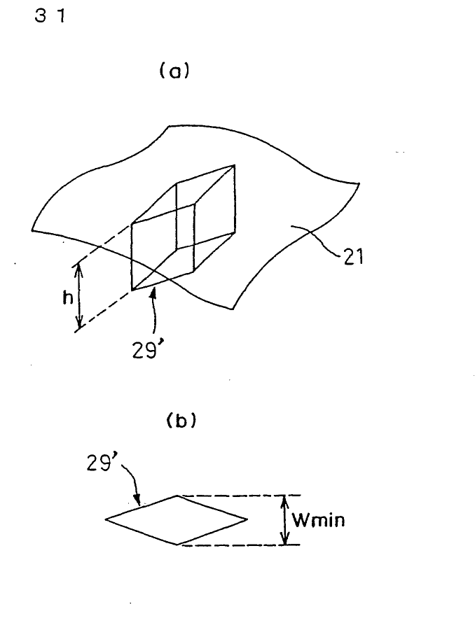

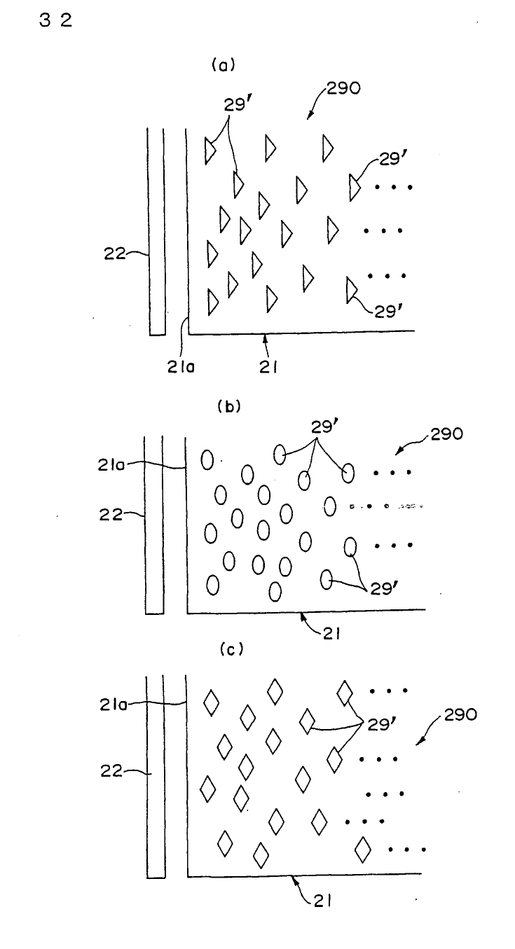

Thus, measures have to be taken to remove such interferences that inevitably occur. The most effective measure to improve the appearance to a practical level without decreasing the optical efficiency as much as possible is to arrange the light takeout mechanism 290 should be arranged irregularly as shown in FIG. 27. With this arrangement, periodicity of light beams emitted from the light guide 21 will disappear almost completely. Thus, even though the base units 28 are periodically arranged on the reflective sheet 27, it is possible to prevent optical interference and thus ugly stripes.

Further, it has been found out that another cause of ugly appearances was irregular gaps between the light guide and the reflective sheet due to slight deflection of the reflective sheet. Thus, it is necessary to provide the reflective sheet with means for keeping an even space between the reflective sheet and the light guide.

On the other hand, since it is necessary that the light reflective sheet 27 used in the present invention be provided with fine base units 28 having inclined light reflecting surfaces 28a on the surface thereof,

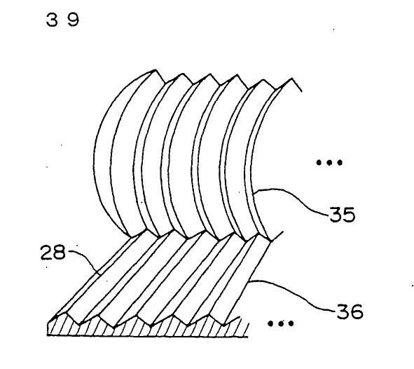

It is also required that the base units 28 can be easily formed on the sheet 27. To meet these two requirements, it is required that the reflective sheet 27 comprises a surface layer 33A on which are formed the base units 28 as shown in FIGS. 36(a) and 36(b), and a backing layer 34 supporting the surface layer 33A, as shown in FIGS. 36(a) and 36(b).

The surface layer 33A is formed of a thermoplastic resin, a photo-curing resin or a thermosetting resin so that the base units 28 can be easily formed while the backing layer 34 is formed of a biaxially oriented thermoplastic resin film which is high in rigidity so that an even space can be maintained between the light guide 21 and the reflective sheet 27. Reflective sheet 27 of such a structure can be manufactured easily at a low cost.

The biaxially oriented thermoplastic resin film as the material for the backing layer 34 is preferably a film of polyethylene terephthalate or polypropylene, and it should be 50-300 μm thick, preferably 70-250 μm thick, more preferably 100-200 μm thick.

Also, the light reflective sheet 27 is preferably convexly warped toward the light guide 21 as shown in FIG. 37(a). By imparting such warp to the light reflective sheet 27, a stress acts such that the light reflective sheet 27 is pressed toward the light guide 21, so that the distance between the light guide 21 and the light reflective sheet 27 can be easily kept constant. But the warp direction as shown in FIG. 37(b) is not preferable because the appearance tends to worsen.

The light reflective sheet 27 used in the present invention is preferably made from a substrate having flexibility and has a thickness of 50-1000 micrometers, preferably 70-500 micrometers, particularly preferably 100-250 micrometers. But the thickness should be suitably selected according to the intended use, and not limited to the above ranges. Also, the effect of the light reflective sheet 27 may also be obtained by integrally molding at a frame of the surface light source device in which is housed the light guide 21.

In order to reflect light beams with a high efficiency, the reflective layer of the reflective sheet 27 is formed of a material having as high a reflectance as possible, i.e. at least 70%, preferably 75% or over, further preferably 85% or over. The reflectance is the percentage of the reflected light beam energy relative to the incoming light beam energy, as specified under JISZ8120. As mentioned above, it is preferable to use a material which can reflect the incoming light beams with minimum energy loss.

Since the present invention relates to devices used for displaying images, the reflectance as used herein refers to the reflectance in typical wavelength range in visible light spectra. Namely, in the base unit having inclined reflective surface, the portion of the reflective sheet near its surface which substantially contribute to the reflection of light has to be formed of a material having high reflectance in the visible spectra range (such as Ag deposit layer), more specifically a material having a reflectance (total beam reflectance) of at least 70% or over, preferably 75% or over, more preferably 85% or over, further preferably 88% or over, most preferably 91% or over, as measured using a spectrophotometer at the wavelength of 550 nm.

The reflective sheet 27 should not be uneven in the color tone. Thus, preferably, it has as flat reflective characteristics as possible in the range of visible light spectra.

The reflectance as used herein refers to the reflectance of the material at least forming the surface of the inclined surfaces 28a of the base units which substantially contributes to the reflection. This material should have high reflectance with least likelihood of changing the color tone, such as silver or aluminum A. A coating layer may be formed on the reflective surface. But the reflectance herein refers to that of the martial that substantially contributes to reflection when no coating layers are applied.

That is, it is preferably formed of a material having such properties as not to cause little change in color tone and to reflect incoming light energy without loss, typically a material having high light reflectance such as silver or aluminum.

Either of the mirror reflection and diffuse reflection can be suitably selected according to required optical property of illuminating light. But for higher directivity, a mirror reflective layer formed of silver or aluminum is preferably used. If a broad emitting angle distribution is desired, a diffuse reflective layer formed of a foamed resin or a resin in which is kneaded a white pigment (white high-reflectance layer) is preferably used.

By forming substantially identically shaped base units 28 from such a high-reflectance material, and arranging them on the reflective sheet 27 as shown in FIGS. 4-10, optical effects such as color condensing and angle changing can be given to light beams selectively directed from the directional emitting element 29 toward the reflective sheet 27.

It is important to arrange the base units 28 with as small a pitch P2 as possible so that the base units cannot be seen on the screen. Specifically, the pitch P2 should be at least 5000 μm or less, preferably 1000 μm or less, more preferably 500 μm or less.

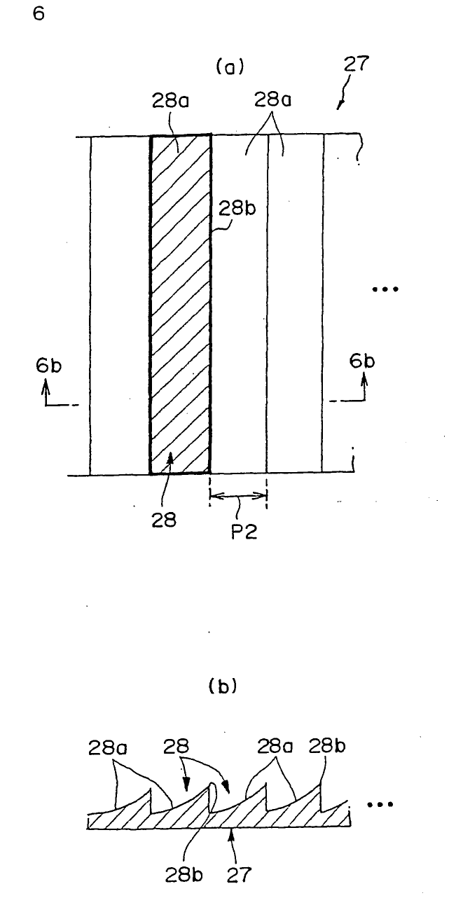

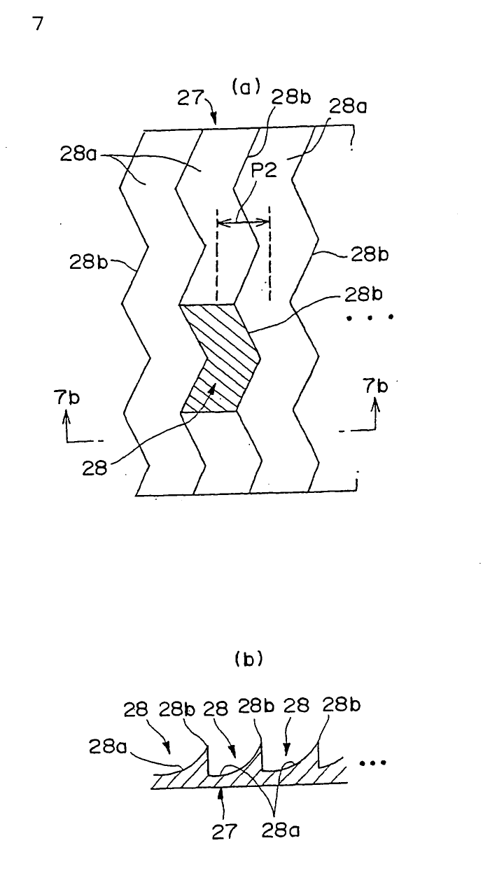

As identical or analogous base units 28 provided on the surface of the reflective sheet 27 and having an inclined reflective surface 28a having a reflectance of 70% or over, typically, the base units 28 should have a serrated cross-section as shown in FIGS. 4(a) and 4(b), but they may have a chevron section as shown in FIGS. 5(a) and 5(b). The base units 28 should be arranged with a pitch of 3000 μm or less, preferably 800 μm or less, more preferably 300 μm or less, and have straight ridges 28b extending parallel to each other as viewed from over the reflective sheet 27 and have flat surfaces.

This is because, as shown in FIG. 4(a), FIG. 4(b), FIG. 5(a) and FIG. 5(b), in the arrangement in which the ridgelines 28b of the inclined flat light reflecting surfaces 28a are arranged substantially parallel to each other, cutting work using a diamond cutting tool or an end mill can be applied, so that the manufacture of a mold for shaping is easy, they can be easily formed finely and the mass-productivity is extremely high.

With this arrangement, most of the light beams emitted from the light guide 21 are directed toward the reflective sheet 27 by the light takeout mechanism 290 comprising protrusions 29a arranged in an irregular pattern, reflected by the flat and straight reflecting surfaces 28a in the direction of the line 23 without developing optical interference, and condensed by the condensing elements 240. Thus, though extremely simple in structure, the surface light source assembly 20 of the invention can produce illuminating light beams that are extremely high in quality.

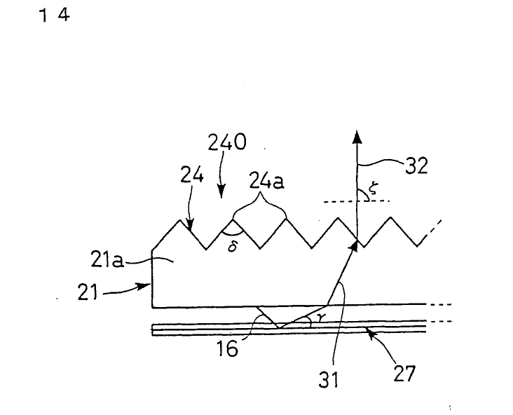

As shown in FIG. 11, the inclination angle α of the inclined reflecting surfaces 28a of the substantially identical and/or substantially analogous base units 28 varies according to the structure of the light takeout mechanism 290. It should be determined such that they can reflect light beams emitted from the light guide 21 in the direction of the line 23.

If the light takeout mechanism 290 comprises the protrusions 29a as in the present invention, the inclination angle α of the reflecting surfaces 28a is preferably 7-50 degrees, more preferably 10-40 degrees, further preferably 15-34 degrees.

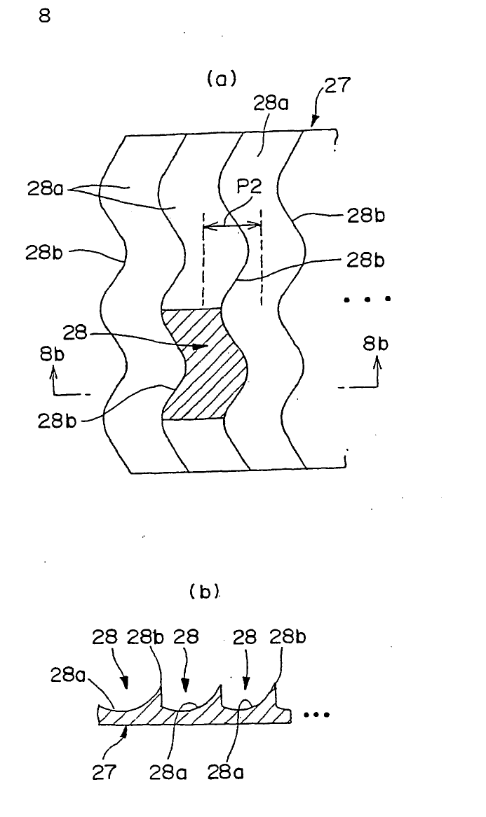

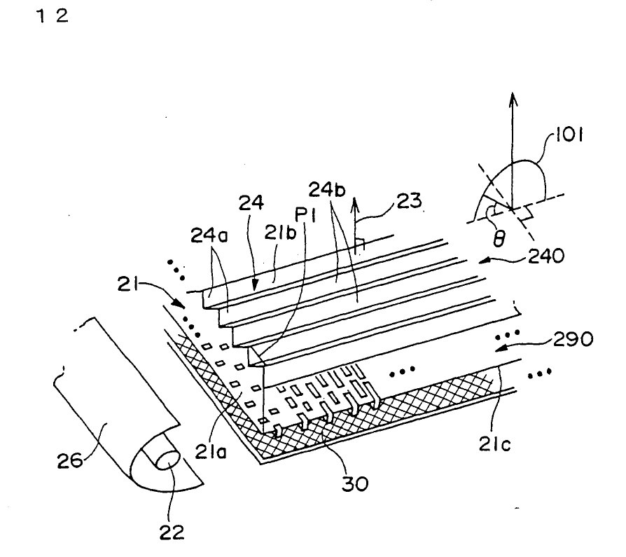

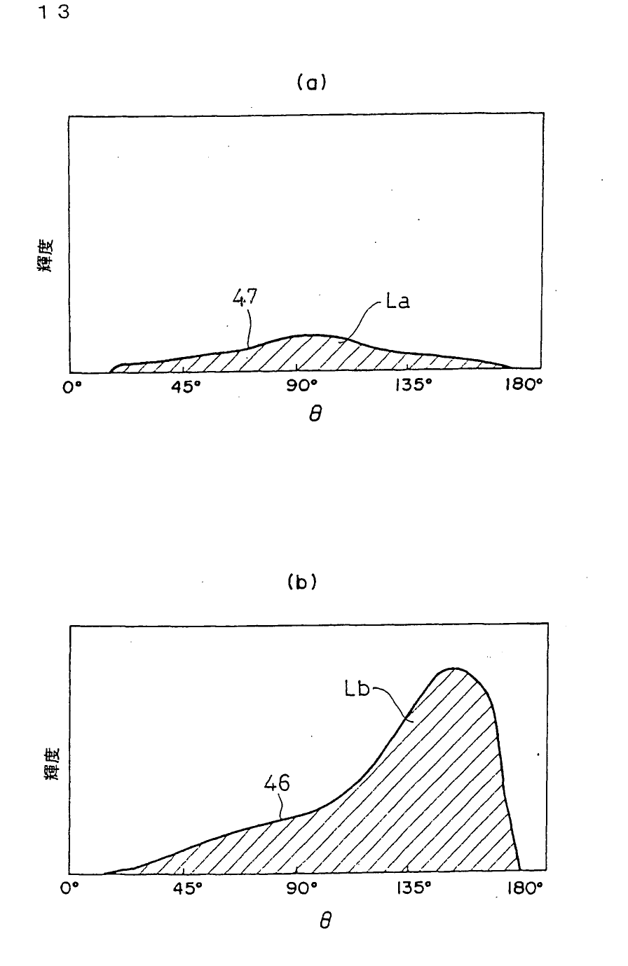

In order to effectively condense light, the reflecting surfaces 28a preferably have an arcuately concave cross-section as shown in FIGS. 6, 7, 9 and 25. As for the sectional shape of the light reflecting surface 28a forming each base unit 28, not only numerous parallel straight and inclined light reflecting surfaces 28, which are suitably used in the present invention, as shown in FIGS. 9 and 10, but the arrangement in which base units 28 in the shape of concave mirrors are arranged may be used.

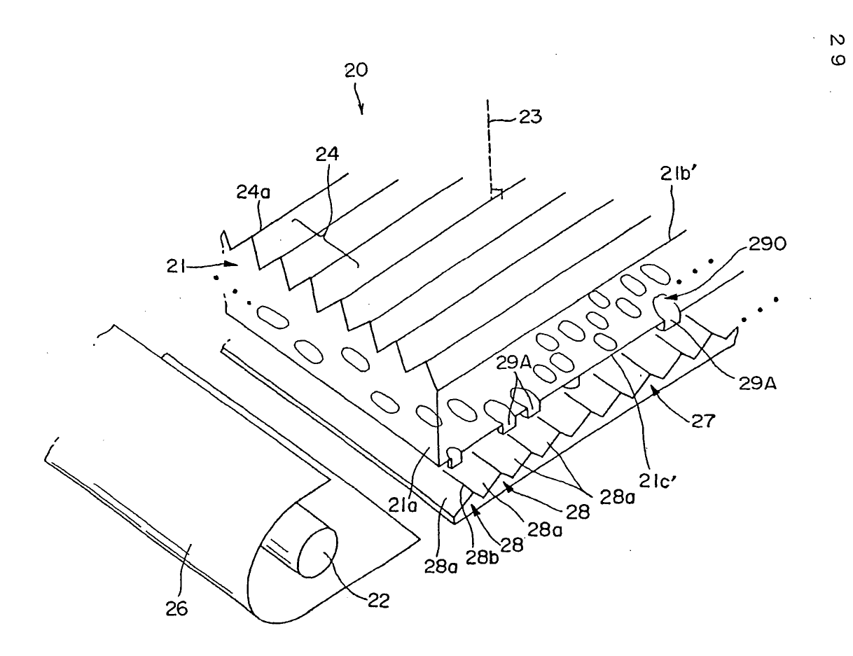

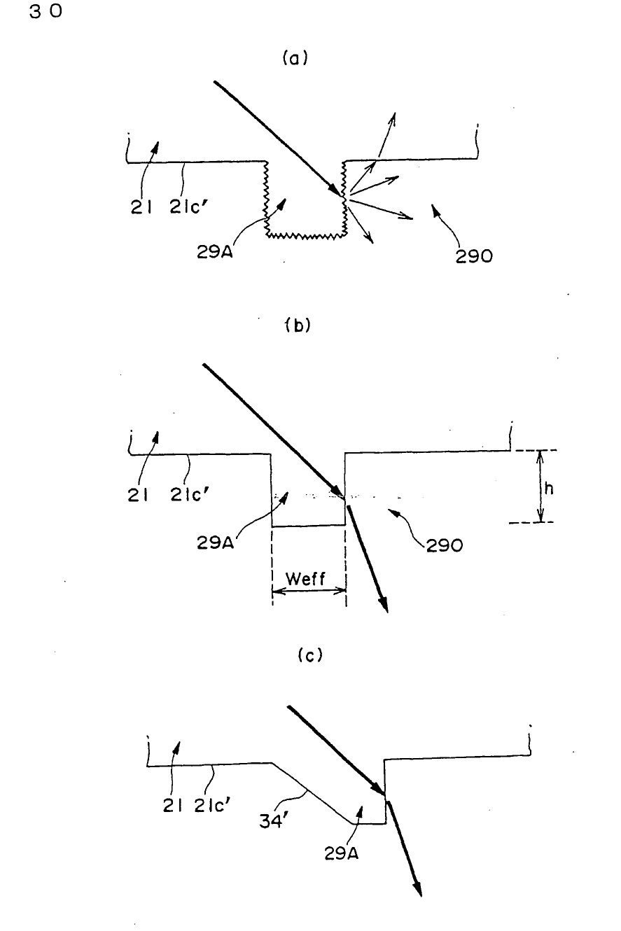

In this case, too, the inclination angle α of the reflecting surfaces 28a should be determined such that they can reflect beams in the direction of the line 23. For example, if the light takeout mechanism 290 comprises the protrusions 29a having flat surfaces, the inclination angle α of the tangent line at the center of the arcuately concave section is preferably 7-50 degrees, more preferably 10-40 degrees, further preferably 15-34 degrees as shown in FIG. 25(b).

By providing the base units 28 comprising the light reflecting surfaces 28a having such a concave section on the light reflective sheet 27 as reflecting elements, it is possible to emit light beams 16 emitted from the light takeout mechanism 290 provided on the light guide 21 and having a broad spread, in the normal direction 23 of the light guide 21 while converting them to light beams 31 having sharper angle properties (light beams that are nearer to parallel beams). In other words, due to the condensing effect of the concave mirrors, it is possible to convert light beams emitted from the light guide 21 to light more collimated and extremely high in luminance relative to the normal direction 23 of the light guide 21.

In other words, the surface light source assembly according to the invention can condense light as efficiently as conventional surface light source assemblies without using an expensive member as used in these conventional assemblies that are expensive and difficult to manufacture, such as a prism array. Thus, the light source assembly according to this invention is simple in structure and can be manufactured with fewer number of steps and higher yield and at a lower cost. Also, dust and debris are less likely to mix.

If the base units 28 are too small, it is difficult to form have a smoothly arcuate concave section. But the reflecting surfaces may have a polygonal concave section instead. If it is necessary to uniformly emit illuminating light in a broad angle range, e.g. if the device of the present invention is used as a backlight module for a liquid crystal TV set, the parallel straight inclined reflecting surfaces may have a convex section to widen the light emitting angle range.

By forming the condensing elements 240 on the light emitting surface 21b of the light guide 21, selectively emitting illuminating light beams toward the light reflecting sheet 27 by forming the light takeout mechanism 290 from directional light emitting elements comprising flat surfaces (particularly preferably a pattern in which a large number of protrusions having flat surfaces are arranged), and arranging the substantially analogous base units 28 on the light reflective sheet 27 to achieve desired optical effects (condensing and changing the angle), the illuminating light beams are subjected to optical condensing function by the light reflective sheet 27. Further, they enter the light guide 21 where the light guide 21 itself acts as a prism sheet, so that they are subjected to optical condensing function again. Thus, compared to conventional surface light source device, it is possible to obtain an optical device which has such a structure that the number of parts is extremely small, but has high controllability of illuminating light beams.

That is, it is possible to achieve the light condensing function without using a member that is expensive and difficult to manufacture such as a prism array shown in FIG. 42, which was needed, two in some cases, in conventional surface light source assemblies. Thus, the present invention provides a light source assembly which is simple in structure, thin as a module, can be manufactured at a low cost with high yield. Dust and debris are less likely to mix. It also has much more advantages.

In the conventional light source assembly shown in FIG. 46, bright lines 9 that worsen the appearance tend to be produced at the side 1a of the light guide 1 along which the light source 2 extends. Such lines 9 are caused by light beams reflected by the reflective sheet 7 and entering into the light guide 11 through its top and bottom surfaces near the side 1b. To remove such bright lines 9, it was necessary to change the position of the reflector or provide light-absorbing printing on the reflective sheet 7. This complicates the structure and increases the manufacturing cost.

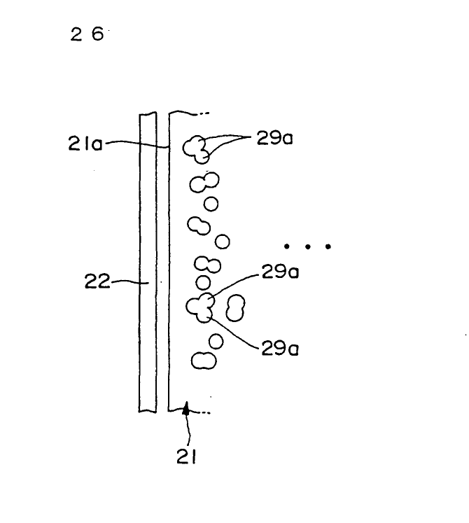

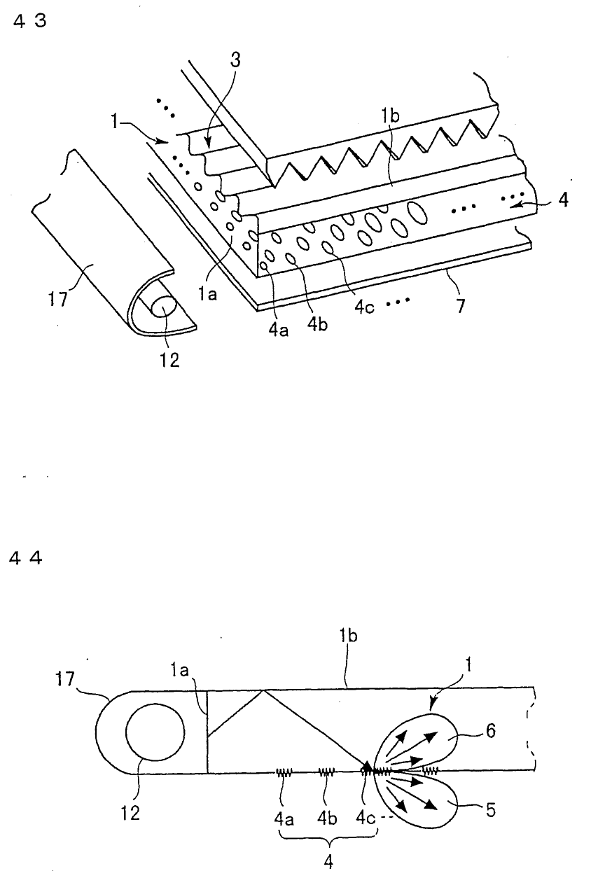

In the light source assembly of the present invention, the inclined reflecting surfaces 28a of the base units 28 reflect light beams (as shown in FIG. 21) which tend to produce bright lines in conventional light source assemblies as shown in FIG. 41, so that no bright lines are produced. Thus, the appearance as the light source improves.

FIGS. 6-10 show various different base units 28 having inclined surfaces 28a on the reflective sheet 27. The reflecting surfaces 28a shown in these figures are all in the shape of concave mirrors having a maximum diameter of 3000 μm or les, preferably 800 μm or less, further preferably 300 μm or less. These reflecting surfaces can condense light not only in the direction perpendicular to the light incoming surface 21a of the light guide 21 but in a direction parallel thereto (that is, two directions perpendicular to each other). Illuminating light can thus be more easily controlled than with the parallel straight inclined surfaces 28a.

In these embodiments in which reflective surfaces 28a in the form of concave mirror are provided, too, light beams from the light emitting element 29 are reflected in the direction parallel to the normal line of the light guide 21 by the reflective sheet 27. Thus, it is possible to condense light in two directions and simultaneously change the direction of light beams toward the light guide.

In these arrangements in which reflective surfaces 28a in the form of concave mirror are provided, too, the range of the inclination angle of the inclined surfaces 28a are the same as described above. That is, as shown in FIG. 11(b), the inclination angle α of the line tangent to the center of the concave cross-section of these reflecting surfaces is preferably 50-7 degrees, more preferably 40-10 degrees, further preferably 34-15 degrees.

The material of the reflective sheet 27 is not specifically limited, but for ease of manufacture, the reflective surfaces 28a are preferably formed by coating the surfaces of silver or aluminum. For higher reflectance, silver is preferable. But aluminum is preferable in view of ease of manufacture and cost. For coating of such a light reflective metal, a dry process such as vacuum deposition, sputtering or ion plating may be used to form a film.

Before e.g. vacuum-depositing silver, the reflective surfaces 28a of the base units 28 may be subjected to mat treatment by e.g. sand blasting. By such a treatment, the mirror-reflective surfaces 28a will have suitable light scattering properties on the light reflective surface, thereby increasing the angle distribution of emitted light beams, reducing glare, and preventing Moire pattern due to interference with gate arrays of liquid crystal cells.

The lustrous metallic (e.g. silver) reflecting surfaces are liable to get damaged and oxidize, and also electric leak tends to occur when the metallic surfaces are exposed. Thus preferably, to form a protective layer 41, silica is applied to the reflecting surfaces by sputtering, or UV-hardening acrylic resin paint is applied. Alternatively, this protective layer 41 may be a coating layer of light transmissive beads, typically glass beads. Such a coating also provides the same effects as the mat treatment for the base unit having inclined light reflective surfaces.

If this transparent coating layer (protective layer 41) is given a function as an optical film, incoming light beams can be controlled more effectively. For example, an optical film such as a λ/4 or λ/2 board may be provided. Also, a plurality of such optical films may be laminated to provide a reflective sheet having the function of controlling polarization of incoming light beams such as beam splitting and polarization conversion.

The light reflective layer is not limited to a metallic layer having a regular reflection property. For example, it may be a diffuse-reflection polyester resin layer in which is kneaded a white pigment such as titanic. This layer scatters light in random directions, thus increasing the directivity of the reflected light and the field of view angle characteristics, compared with a regular-reflection reflective layer such as Ag film.

Such a diffuse-reflection layer may be formed of a foamed polyester resin, foamed polyolefin resin or foamed ABS resin, or may be formed by coating a white pigment. In the preferred embodiment, the reflective sheet 27 is preferably formed of a resin, particularly a polyester resin, an acrylic resin, polycarbonate resin or cyclic polyolefin resin. The concave reflective surface array is shaped by hot pressing or is formed by shaping a photo-curing resin.

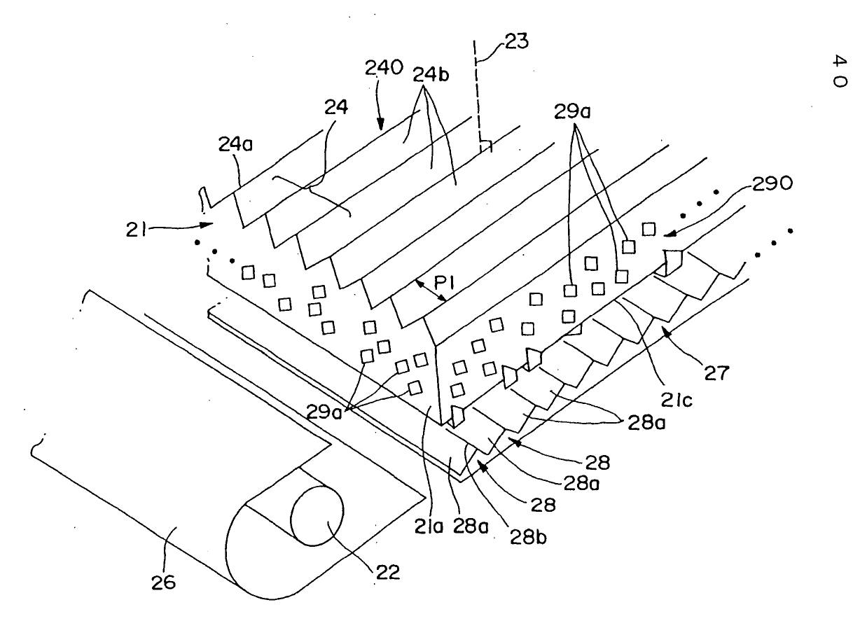

The reflective sheet 27 is preferably manufactured continuously by a roll-to-roll process as shown in FIG. 38, because with this process, such sheets 27 can be mass-produced with stable quality. In the roll-to-roll process, as shown in FIG. 38, the base units 28 are continuously formed on a thermoplastic film 36, and a backing layer 28 is continuously laminated while the film 36 is being supplied from a supply roll 38 toward a takeup roll 39.

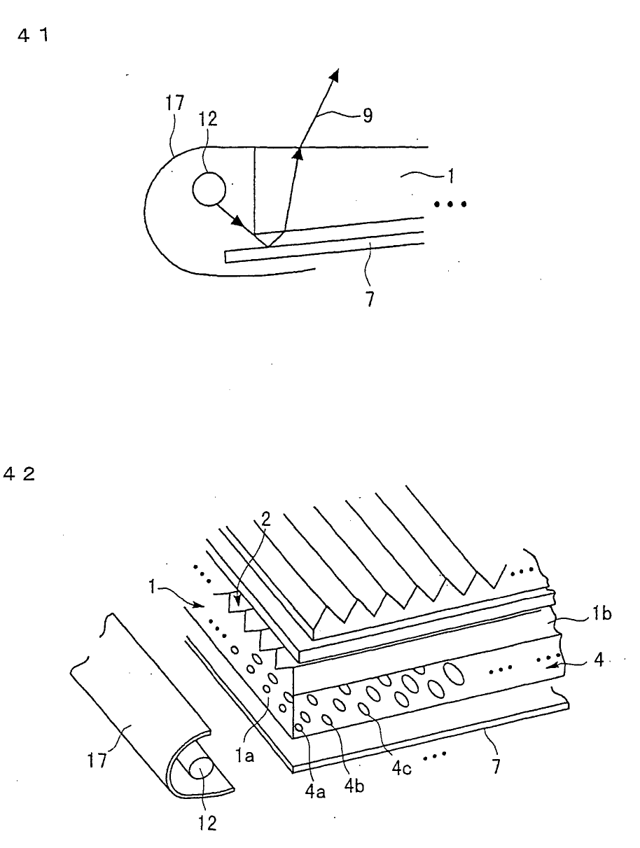

The base units 28 are formed by shape transfer on a thermoplastic resin film 36 of polycarbonate from a heated emboss roll 35 formed with the shape of base units having inclined surfaces (FIG. 39). As the back support layer 34, a biaxially oriented thermoplastic film 37 is laminated on the back, i.e. the surface not formed with the base units, of the film 36 (FIG. 38). This method using a roll-to-roll process is high in productivity and needs a simple apparatus, and thus is preferable.

This laminated structure of the reflective sheet 27 prevents Moire pattern and other phenomena that can worsen the appearance when used with a large liquid crystal module. Also, a surface light source assembly is obtained which is simple in structure but sufficiently practical in every respect.

Next, the structure of the members forming the surface light source will be described in more detail.

The light takeout mechanism 290 of the light guide 21 preferably comprises flat-surfaced protrusions having a protruding amount of 2-300 μm, preferably 5-200 μm, further preferably 10-100 μm, and irregularly distributed to prevent interference.

Explaining the shape of the protrusions 29a in more detail, with the light guide having a light takeout mechanism in the form of protrusions 29a, the rate at which light beams are directed toward the reflective sheet is mainly determined by the ratio of the depth h of the protrusions 29a to the width Weff (effective opening width), which is the width of the protrusions as viewed in section in a direction (arrow 33) perpendicular to the side along which the light source is provided as shown in FIG. 20(a).

That is, the greater this ratio, the greater the amount of light beams emitted toward the reflective sheet 27 as shown by the optical path 16 of FIG. 50(b) because the amount of the light beams total-reflected by the bottoms of the protrusions and not finding way to the reflective sheet reduces.

The ratio h/Weff is preferably 0.3-1.5, more preferably 0.5-1.3, further preferably 0.7-1.2. Thus it is preferable that illuminating light beams are intensively emitted toward the light reflective sheet.

To prevent optical interference, the protrusions 29a should be as randomly and irregularly as possible. But if they are arranged too irregularly, adjacent protrusions may abut each other, thus damaging each other such that the ratio h/W changes. Thus, they should be arranged randomly but not contact each other as shown in FIG. 27.

If not so high luminance is required, as with conventional arrangements, the protrusions may comprise rough surfaces for the light takeout mechanism. But the protrusions have to be arranged as irregularly as possible to prevent optical interference.

The condensing elements 240 comprising a triangular prism array 24 or array elements 25 having a sine curve section are provided on at least one of the surfaces of the light guide 21, as in the surface light source assemblies of the embodiments of FIGS. 1 and 2, are preferably provided such that their ridges are perpendicular to the side along which the light source is provided. Their functions will be described.

As shown in FIG. 14, the light takeout mechanism 290 comprising the protrusions 29a having flat surfaces, first directs most of the light emitted from the light guide toward the reflective sheet. The substantially identically shaped base units, which have inclined reflecting surfaces, change the direction of light beams in the normal direction. Light beams thus enter the light guide again, and are condensed by the condenser elements in the form of triangular prism array.

There are conventional arrangements in which e.g. an array of triangular prisms is integrally formed on the light guide to improve condensing property. Compared to such conventional arrangements, the surface light source assembly according to the invention is completely different from an optical viewpoint and is superior in condensing property. This is apparent from FIGS. 14 and 45.

That is, in the conventional surface light source assemblies, because the amount of light beam components that directly proceed to the light emitting surface 1b of the light guide was large, as is apparent from the path shown in FIG. 45, they pass the interface between the light guide and an air layer only once, so that it was impossible to sufficiently condense light.

But in the surface light source assembly of the invention, as shown in FIG. 14, most part 16 of the emitted light from the light guide 21 is first directed toward the reflective sheet 27. Thus, as is apparent from the path shown in FIG. 14, light beams pass the interface between the light guide 21 and an air layer twice. Thus, the light guide 21 itself acts as a thick lens array sheet. The condensing property is thus superior.

The surface structure of the condensing elements 240 is not particularly limited because its design aim is to increase the condensing property. But if the inherent function of the light guide 21 of transferring light beams entering through the side based on total reflection without loss is lost, the surface light source assembly would lose its function.

Thus, the ridges 24b, 25b of the condensing elements 240 are arranged in the direction perpendicular to the side along which the light source is provided. This prevents the turbulance of total reflection by the condensing elements 240. This allows light to more easily transfer through the light guide. Also, the condensing elements fully reveal their function.

The condensing elements provided on the light guide 21, in the form of triangular prism array 24 or sine curve concave or convex, are preferably so small as not to be seen by the naked eye. Specifically, their pitch is 1-500 μm, preferably 5-300 μm, further preferably 10-150 μm. Specifically, they may be triangular prism array 24 shown in FIG. 1, or array elements 25 having a sine curve section.

The triangular prism array 24 shown in FIG. 1 is particularly preferable in view of condensing properties and workability. The triangular prism array 24 having a apex angle δ of 60-150 degrees, preferably 70-120 degrees, further preferably 80-110 degrees are provided on the light emitting surface of the light guide 21, with the ridges 24a of the prism array 24 perpendicular to the side 21a along which the light source 22 is provided.

Integrally forming such a triangular prism array 24 on the light emitting surface 21b of the light guide 21 makes it possible for the light guide itself to act as a thick prism sheet. Thus, it is far superior in the optical properties compared to conventional devices in spite of its simple structure.

The surface light source assembly of the present invention may be provided on the back of a light transmissive liquid crystal panel to provide a liquid crystal display device that is thin, superior in image quality (less bright lines), simple in structure, easy to assemble, high in yield and inexpensive.

In the present invention, a liquid crystal display device refers to a device in which display is carried out using liquid crystal cells, which are an array of optical shutters, in which using the electro-optical effect of liquid crystal molecules, i.e. optical anisotropy (anisotropy in reflectance), orientation, etc., the oriented state of liquid crystals are changed by applying electric field or passing current to arbitrary display units, and which are driven by changing the light beam transmission and/or reflectance.

Specifically, such liquid crystal display elements include a transmission type simple matrix-drive super-twisted nematic mode, a transmission type active matrix-drive twisted nematic mode, a transmission type active matrix-drive inplane switching mode, and a transmission type active matrix-drive multi-domain vertical aligned mode.

According to the invention, compared with the above-described surface light source assembly, which was insufficient in the practical quality of illuminating light beams (slight unevenness in the emitting surface, such as Moire fringe or Newton ring), though simple in structure and high in illuminating efficiency, sufficient properties for practical use are imparted. By using the surface light source assembly of the invention as a backlight of a liquid crystal display element, a liquid crystal display device is provided that is superior in optical efficiency, simple in structure, easy to assemble, and inexpensive.

### EXAMPLES

Examples according to the invention are now described. The present invention is not limited to these examples.

### Example 1

As the light guide, a 215.0×163.0 mm wedge-shaped acrylic board (made by Mitsubishi Rayon Co., Ltd., Acrypet TF8) whose thickness decreases in the direction of its short sides and having a minimum thickness of 0.6 mm along one long side was used. At the portion where the thickness is maximum, a linear light source in the form of cold cathode tube (made by Sanken Electric Co., Ltd. 2.0 dia.) was provided. As shown in FIG. 19(a), rectangular protrusions having flat surfaces were formed on the surface of the light guide opposite its light emitting surface so that the farther from the linear light source, the longer the protrusions would be in one axial direction (direction parallel to the linear light source. FIG. 20(c) shows an enlarged such protrusion. The depth h of the protrusions were 27.0 μm, and the minimum opening width W min of the protrusions was 45 μm.

The light guide was formed by injection molding. A mold having openings corresponding to the protrusions and used to form the protrusions was formed by laminating a glass sheet on a dry film resist (made by Nichigo-Morton Co., Ltd.) having a thickness of 25 μm, forming a patten by photolithography, depositing electrodes on the glass sheet on which was formed the pattern by use of the dry film resist, and carrying out electrocasting using it as the electrocasting master.

As the light condensing elements 240, as shown in FIG. 1, an array 24 of triangular prisms having an apex angle of 90 degrees and a pitch of 50 μm was formed on the light emitting surface 21b (that is, the surface on which the light takeout mechanism 290 was not formed) of the light guide 21 such that the ridges 24a of the triangular prism array 24 would be substantiality perpendicular to the side along which the linear light source 12 was arranged (that is, light incoming surface 21a).

The directional light emitting elements 29 of the light guide 21, that is, the protrusions were formed with high smoothness. The surface roughness of the protrusions, as measured using an optical surface shape meter (made by Keyence Corporation, VK-8500), was 0.35 micrometer in arithmetic average roughness Ra. Such smooth surfaces prevented or almost prevented unnecessary light scattering. Thus, 77% of the light beams emitted from the light guide were directed toward the reflective sheet.

FIG. 6 shows a section of the reflective sheet 27 used. The sheet includes parallel, straight inclined surfaces 28a of which the ridges are arranged parallel to each other with a pitch of 100 micrometers. As the reflective layer, a sputtering layer of silver having a reflectance of 91.2% was used. An overcoating layer of silica was further formed on the silver sputtering layer. The inclined surfaces 28a were inclined at an angle of 29 degrees and had a concave cross-section to change the angles of light beams emitted through the directional light emitting elements 18 having flat surfaces and condense them.

A surface light source device was turned on by high frequency through an inverter (made by Harison Electric Co., Ltd.). Most of the light beams emitted from the light guide are first directed toward the reflective sheet where their angles are changed and condensed. Since the light guide itself acts as a prism sheet to condense the light, the illuminating light has an extremely high directivity in the forward direction. Thus such a light is ideal as a backlight for a liquid crystal display device.

The average brightness was measured at 25 points on the screen by use of a brightness measuring device (made by TopCom Inc., BM-7) with a tube current of 6 mA. The average brightness was 1820 nit and the unevenness of brightness was 75% (that is, min/max×100). These values are practically sufficient for use as a backlight for a liquid crystal display device.

In the conventional arrangement, two prism sheets are needed. In the present invention, no prism sheet is needed. Thus, there is no need to worry about dust trapped between the prism sheets. The device of the present invention is easy to assemble, and is pretty thin and lightweight because no prism sheet is used. Thus a thin and lightweight surface light source device is obtained. Further, due to the effect of the light reflective sheet, the device of the present invention is free from bright lines that tend to appear near the light source in the conventional light source device without any particular measures needed. The image quality is thus high. Further, since the directional light emitting elements for controlling the distribution of brightness are in the form of the protrusions, their pattern can be easily changed or modified. Practicality is thus high.

### Example 2

As the light guide 21, a 289.6×216.8 mm wedge-shaped cyclic polyolefin resin (made by Zeon Corporation, Zeonor) was used whose thickness changed in the direction of its short sides and which had a thickness of 2.0 mm at a thick portion and 0.6 mm at a thin portion. Along the long side of the thick side, a linear light source 22 in the form of a cold cathode tube (made by Harison Toshiba Lighting Corporation) having a tube diameter of 1.8 mm was provided. The cold cathode tube was covered by a reflector plate (made by Mitsui Chemicals, Inc., silver reflector plate) of which the reflecting surface was an Ag deposit layer so that the light beams from the light source 22 would efficiently enter the light guide 21 through its light incoming surface 21b.

On the surface 21c of the light guide 21 opposite to the light emitting surface 21b, protrusions 29a were formed by patterning such that the farther from the linear light source 22, the more the length L in the direction parallel to the light incoming surface 21a of the light guide 21 increased with their effective opening widths substantially constant. As shown in FIG. 20(c), the protrusions 29a had a depth of 50.0 micrometers and an effective opening width W min of 72.0 micrometers. Their length L varies between 85 and 270 micrometers.

The mold used to form the protrusions 29a were formed by laminating a dry film resist 50 micrometers thick on a SUS board, forming a pattern by photolithography, depositing Ni electrodes on the SUS board on which was formed the pattern by the dry film resist, and nickel-electrocasting by using it as a master. Using this mold formed with the projections having a smooth surface, the light guide was formed by injection molding in an injection molder (made by Toshiba Machine Co., Ltd.).

As shown in FIG. 1, condensing elements 240 having a corrugated pattern in the form of an array 24 of triangular prisms having an apex angle of 90 degrees were formed on the light emitting surface 21b of the light guide 21 with their ridges 24a extending perpendicular to the side 21a which was the light incoming surface of the light guide 21.

By using such a pattern comprising the protrusions 29a with flat surfaces as the light takeout mechanism 290 and defining the shape of the light takeout mechanism 290 so that the effective opening width of the protrusions 29a would be constant, it was possible to provide a light guide 21 with which illuminating light beams are selectively emitted toward the light reflective sheet 27 and the selectivity of light beams toward the reflective sheet 27 was kept constant in the light emitting surface 21b.

In order to measure the emitting direction selectivity rate of the light guide 21, as shown in FIG. 12, a black sheet 30 having a reflectance of 2% or less was arranged at a position where the reflective sheet 27 was to be placed, and the light emitting angle distribution in a given direction 101 in a plane that was perpendicular to the side 21a of the light guide 21 along which the light source 22 is provided and is parallel to the normal line 23 was measured with a luminance meter (made by TopCom Inc., BM-7). The measurement results at the center are shown in FIG. 13(a).

Next, with the light guide 21 turned over (so that the light emitting surface 21b would face the black sheet 30), the emitting angle distribution was measured in the same manner as above. The measurement results are shown in FIG. 13(b). The curves 47 and 46 were integrated in the range of 0-180 degrees to determine values La and Lb. The emitting direction selectivity rate at the central Position of the light emitting surface, which is given by Lb/(La+Lb), was 78%. Thus it was confirmed that an Optical system was obtained with which light beams were Emitted selectively toward the reflective sheet 27.

Further, similar measurements were performed at 25 points in the effective illuminating area shown in FIG. 18. The results are shown in Table 1.

TABLE 1

| | | | | |
|---|---|---|---|---|
| 75 | 74 | 73 | 68 | 66 |
| 74 | 77 | 79 | 72 | 69 |
| 72 | 74 | 78 | 75 | 71 |
| 77 | 80 | 81 | 79 | 74 |
| 79 | 84 | 82 | 80 | 77 |

Since the protrusions 29a were shaped such that the emitting direction selectivity would not vary so much, the fluctuation in the the light emitting surface 21b was −12.1 to 11.1% relative to the average. The light beam selectivity toward the reflective sheet 27 was stable at any point. Thus it was confirmed that a light guide suitable for use with the surface light source according to the present invention was provided.

The reflective sheet 27 was used which had a shape shown in FIG. 4, and had as base units 28 reflecting surfaces 28a having parallel ridges 28b and having a serration-shaped section. The pitch P2 was 100 μm. For the reflecting layer, an aluminum deposit layer was used. On the aluminum deposit layer, silica was coated by sputtering.

The inclination angle α of the reflecting surfaces 28a was 31 degrees. An optical system was obtained in which light beams selectively directed toward the reflective sheet 27 were reflected by the reflective sheet 27 and condensed by the triangular prism array 24 provided on the light emitting surface 21b of the light guide 21 to emit light in the direction of the normal line 23 of the light guide 21.

The cold cathode tube light source 22 was turned on at high frequency through the inverter to provide a surface light source. The average brightness was measured at 5 points by use of a luminance meter (made by TopCom Inc., BM-7) with the tube current set at 5 mA. The average brightness was 1873 nit. Thus, it was confirmed that the optical characteristics were sufficient in both brightness and unevenness of brightness for use as a backlight for a liquid crystal display panel.

Since the illuminating light beams were sufficiently condensed both in the horizontal and vertical directions, their properties were sufficient for use as backlight particularly for liquid display devices used in laptop or notebook personal computers and handhold computers. Further, since it had no prism sheet, which was used in conventional arrangements, there was no need to worry about failure due to dust trapped between the sheets, and the device can be assembled easily and the yield was high.

No bright lines were observed, which were often observed near the light source in conventional devices. The pattern of the light takeout mechanism 290 comprising the protrusions 29a can be changed easily. Thus, the appearance adjustment can be made in a short time.

The rate of illuminating light beams directed toward the reflective sheet 27 was kept constant, so that unevenness of brightness was low even when the light emitting surface was seen obliquely. This means that it is very useful as the surface light source for liquid crystal display devices.

### Example 3

A light guide 21 having a shape identical to the light guide of Example 2 was used. A light takeout mechanism 290 was used which comprised substantially identically shaped protrusions 29a having smooth flat surfaces and arranged such that their density gradually increased as they are farther from the light source 22 as shown in FIG. 19(b). The effective opening width W of the protrusions 29a was substantially constant at 75.0 micrometers. Their openings were square as shown in FIG. 20(b) and their depth h was 50.0 micrometers.

The same triangular prism array 24 as used in Example 2 was used. The emitting direction selectivity rate measured at 25 points in the light emitting surface. The results are shown in Table 2. The emitting direction selectivity rate at the central position was 81% with the variation range in the light emitting surface of 9.6-10.2% with respect to the average value. Thus it was confirmed that irrespective of places, the light beam selectivity toward the reflective sheet 27 was stable and an extremely suitable light guide was obtained for use in the surface light source device of the present invention.

TABLE 2

| | | | | |
|---|---|---|---|---|
| 74 | 74 | 75 | 72 | 70 |
| 75 | 78 | 79 | 75 | 71 |
| 75 | 77 | 81 | 76 | 72 |
| 79 | 80 | 83 | 79 | 77 |
| 80 | 84 | 85 | 82 | 80 |

The same reflective sheet 27 and the same cold cathode tube as used in Example 2 were used. Through an inverter, the cold cathode tube light source 22 was turned on by high frequency to obtain a surface light source assembly. The average brightness measured with the tube current set at 5 mA was 1945 nit. Thus, it was confirmed that the brightness and the unevenness of brightness were sufficient for use as a backlight for a liquid crystal display panel.

As with Example 2, the rate of illuminating light beams emitted from the light emitting surface toward the reflective sheet was constant, so that unevenness of brightness changed little when the light emitting surface was seen obliquely. This makes the device of this invention very useful as a surface light source assembly for a liquid crystal display device. Since it had no prism sheet, which was used in conventional devices, failure due to dust trapped between the sheets hardly occurred. Also, it can be assembled easily and yield was high.

### Example 4

As the light guide 21, a 289.6×216.8 mm wedge-shaped cyclic polyolefin resin (made by Zeon Corporation, Zeonor) was used whose thickness changed in the direction of its short sides and which had a thickness of 2.0 mm at a thick portion and 0.6 mm at a thin portion. Along the long side of the thick side, a linear light source 22 in the form of a cold cathode tube (made by Harison Toshiba Lighting Corporation) having a tube diameter of 1.8 mm was provided. The cold cathode tube was covered by a reflector plate (made by Mitsui Chemicals, Inc., silver reflector plate) of which the reflecting surface was an Ag deposit layer so that the light beams from the light source 22 would efficiently enter the light guide 21 through its light incoming surface 21b at the side of the thick portion.

On the surface 21c of the light guide 21 opposite to the light emitting surface 21b, rod-like protrusions 29a were formed by patterning such that the farther from the linear light source 22, the larger the diameter. As shown in FIG. 20(c), the protrusions 29a had a depth of 50.0 micrometers and an effective opening width W min of 35.0 to 145.0 micrometers. Also, as shown in FIG. 27(a), the protrusions 29a are arranged in a random distribution so as not to contact with one another. This is because regular arrangement of the protrusions might cause undue optical interference.

The mold used to form the protrusions 29a were formed by laminating a dry film resist 50 micrometers thick on a SUS board, forming a pattern by photolithography, depositing Ni electrodes on the SUS board on which was formed the pattern by the dry film resist, and nickel-electrocasting by using it as a master. Using this mold formed with the projections having a smooth surface, the light guide was formed by injection molding in an injection molder (made by Toshiba Machine Co., Ltd.).

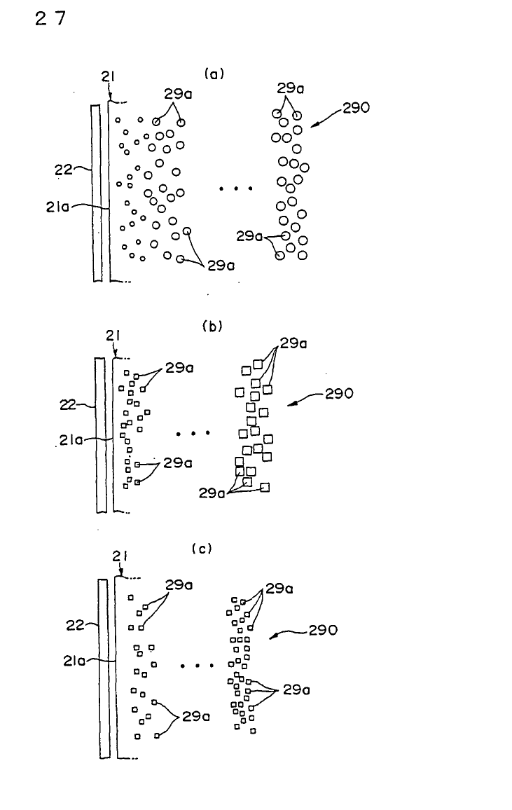

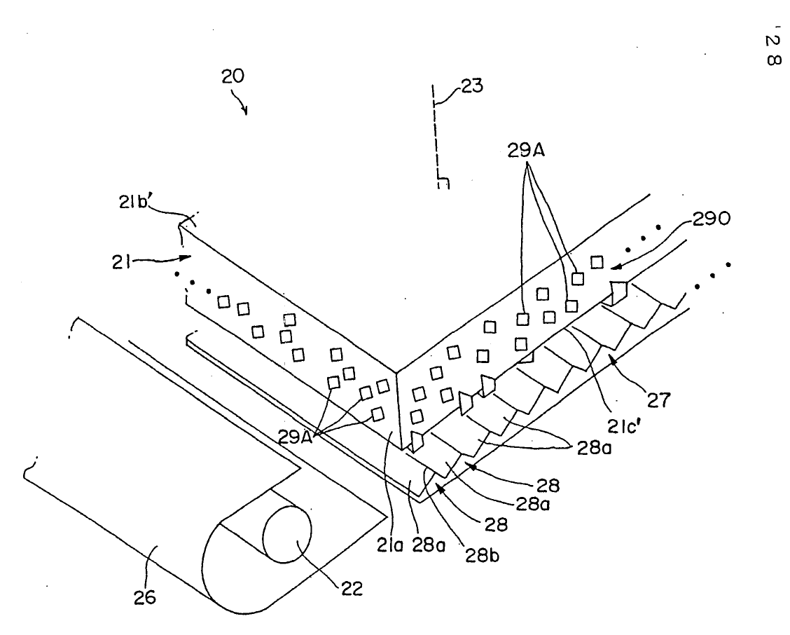

As shown in FIG. 23, condensing elements 240 in the form of an array 24 of triangular prisms having an apex angle of 90 degrees were formed on the light emitting surface 21b of the light guide 21 with their ridges 24a extending perpendicular to the side 21a which was the light incoming surface of the light guide 21.

In order to measure the emitting direction selectivity rate of the light guide 21, as shown in FIG. 12, a black sheet 30 having a reflectance of 2% or less was arranged at a position where the reflective sheet 27 was to be placed, and the light emitting angle distribution in a given direction 101 in a plane that was perpendicular to the side 21a of the light guide 21 along which the light source 22 is provided and is parallel to the normal line 23 on the light emitting surface 21b was measured with a luminance meter (made by TopCom Inc., BM-7). The measurement results at the center on the light emitting surface 21b are shown in FIG. 13(a).

Next, with the light guide 21 turned over (so that the light emitting surface 21b would face the black sheet 30), the emitting angle distribution was measured in the same manner as above. The measurement results are shown in FIG. 13(b). The curves 47 and 46 were integrated in the range of 0-180 degrees to determine values La and Lb. The emitting direction selectivity rate at the central position of the light emitting surface, which is given by Lb/(La+Lb), was 72%. Thus it was confirmed that an optical system was obtained with which light beams were emitted selectively toward the reflective sheet 27.

The reflective sheet 27 was used which had a shape shown in FIG. 4, and had as base units 28 reflecting surfaces 28a having parallel ridges 28b and having a serration-shaped section. The pitch P2 was 50 μm. For the reflecting layer, an aluminum deposit layer was used. On the aluminum deposit layer, silica was coated by sputtering.

The inclination angle α of the reflecting surfaces 28a was 31 degrees. An optical system was obtained in which light beams selectively directed toward the reflective sheet 27 were reflected by the reflective sheet 27 and condensed by the triangular prism array 24 provided on the light emitting surface 21b of the light guide 21 to emit light in the direction of the normal line 23 of the light guide 21.

The cold cathode tube light source 22 was turned on at high frequency through the inverter to provide a surface light source. Even with careful view of the light emitting surface 21b, no Moire fringe or Newton Ring was observed and the reflective sheet 27 deflected slightly, but no evenness in luminance was detected. As a result, the surface light source showed practically satisfactory appearance and quality. The average brightness was measured at 5 points by use of a luminance meter (made by TopCom Inc., BM-7) with the tube current set at 5 mA. The average brightness was 1745 nit. Thus, it was confirmed that the optical characteristics were sufficient in both brightness and unevenness of brightness for use as a backlight for a liquid crystal display panel.

Since the illuminating light beams were sufficiently condensed both in the horizontal and vertical directions, their properties were sufficient for use as backlight particularly for liquid display devices used in laptop or notebook personal computers and handhold computers. Further, since it had no prism sheet, which was used in conventional arrangements, there was no need to worry about failure due to dust trapped between the sheets, and the device can be assembled easily and the yield was high.

No bright lines were observed, which were often observed near the light source in conventional devices. The pattern of the light takeout mechanism 290 comprising the protrusions 29a can be changed easily. Thus, the appearance adjustment can be made in a short time.

### Comparative Example 1

A surface light source assembly was manufactured using the same light guide used in Example 4 except that the protrusions 29a having flat surfaces were arranged not randomly but regularly.

Easily recognizable patterns resulting from optical interference appeared on the light emitting surface. When the reflective sheet deflected only slightly, they appeared in more exaggerated form. Thus, the illuminating quality was inferior. So a sufficient illuminating quality for use as a backlight source for a large liquid crystal display was not obtained.

### Example 5

As the light guide 21, a 289.6×216.8 mm wedge-shaped cyclic polyolefin resin (made by Zeon Corporation, Zeonor) was used whose thickness changed in the direction of its short sides and which had a thickness of 2.0 mm at a thick portion and 0.6 mm at a thin portion. Along the long side of the thick side, a linear light source 22 in the form of a cold cathode tube (made by Harison Toshiba Lighting Corporation) having a tube diameter of 1.8 mm was provided. The cold cathode tube was covered by a reflector plate (made by Mitsui Chemicals Inc., silver reflector plate) of which the reflecting surface was an Ag deposit layer so that the light beams from the linear light source 22 would efficiently enter the light guide 21 through its light incoming surface 21b at the side of the thick portion.

On the surface 21c of the light guide 21 opposite to the light emitting surface 21b, as shown in FIG. 40, diamond-shaped protrusions 29a were formed by patterning such that the farther from the linear light source 22, the more the diameter would increase. The protrusions 29a had a depth of 80.0 micrometers and an effective opening width W min increasing in the range of 65.0 to 140.0 micrometers. Also, as shown in FIG. 40, the protrusions 29a are arranged in a random distribution so as not to contact with one another. This is because regular arrangement of the protrusions might cause undue optical interference.

The mold used to form the protrusions 29a were formed by laminating a dry film resist 80 micrometers thick on a SUS board, forming a pattern by photolithography, depositing Ni electrodes on the SUS board on which was formed the pattern by the dry film resist, and nickel-electrocasting by using it as a master. Using this mold formed with the projections having a smooth surface, the light guide was formed by injection molding in an injection molder (Toshiba Machine Co., Ltd.).

As shown in FIG. 23, condensing elements 240 having a corrugated pattern in the form of an array 24 of triangular prisms having an apex angle of 90 degrees were formed on the light emitting surface 21b of the light guide 21 with their ridges 24a extending perpendicular to the side 21a which was the light incoming surface of the light guide 21.

In order to measure the emitting direction selectivity rate of the light guide 21, as shown in FIG. 12, a black sheet 30 having a reflectance of 2% or less was arranged at a position where the reflective sheet 27 was to be placed, and the light emitting angle distribution in a given direction 101 in a plane that was perpendicular to the side 21a of the light guide 21 along which the light source 22 is provided and is parallel to the normal line 23 was measured with a luminance meter (made by TopCom Inc., BM-7). The measurement results at the center are shown in FIG. 13(a).

Next, with the light guide 21 turned over (so that the light emitting surface 21b would face the black sheet 30), the emitting angle distribution was measured in the same manner as above. The measurement results are shown in FIG. 13(b). The curves 47 and 46 were integrated in the range of 0-180 degrees to determine values La and Lb. The emitting direction selectivity rate at the central position of the light emitting surface, which is given by Lb/(La+Lb), was 81.2%. Thus it was confirmed that an optical system was obtained with which light beams were emitted selectively toward the reflective sheet 27.

The reflective sheet 27 was used which had a shape shown in FIG. 4, and had as base units 28 reflecting surfaces 28a having parallel ridges 28b and having a serration-shaped section. The pitch P2 was 50 μm. For the reflecting layer, an aluminum deposit layer was used. On the aluminum deposit layer, silica was coated by sputtering.

The base unit 28 on the surface of the reflective sheet was formed by continuous embossing by roll-to-roll process as shown in FIG. 38 by use of an embossing roll 35 heated over the heat deformation temperature with a non-oriented polycarbonate film (50 μm thick) as the surface layer 33A as shown in FIG. 36.

The non-oriented polycarbonate film for forming the base unit was bonded to biaxial oriented polyethylenetelephthalate film (175 μm thick) as a backing layer 34 to ensure rigidness, thereby forming a substrate for the reflective sheet 27. As shown in FIG. 37(a), the reflective sheet 27 was arranged so that the base unit formed side would be convex as shown in FIG. 27(a).

The inclination angle α of the reflecting surfaces 28a was 32.5 degrees. An optical system was obtained in which light beams selectively directed toward the reflective sheet 27 were reflected by the reflective sheet 27 and condensed by the triangular prism array 24 provided on the light emitting surface 21b of the light guide 21 to emit light in the direction of the normal line 23 of the light guide 21.

The cold cathode tube light source 22 was turned on at high frequency through the inverter to provide a surface light source. Even with careful view of the light emitting surface 21b, no Moire fringe or Newton ring was observed and the reflective sheet 27 deflected slightly, but no evenness in brightness was detected. As a result, the surface light source showed practically satisfactory appearance and quality.

The average brightness was measured at 25 points by use of a luminance meter (made by TopCom Inc., BM-7) with the tube current set at 5 mA. The average brightness was 1697 nit. Thus, it was confirmed that the optical characteristics were sufficient in both brightness and unevenness of brightness for use as a backlight for a liquid crystal display panel.

Since the illuminating light beams were sufficiently condensed both in the horizontal and vertical directions, their properties were sufficient for use as backlight particularly for liquid display devices used in laptop or notebook personal computers and handhold computers. Further, since it had no prism sheet, which was used in conventional arrangements, there was no need to worry about failure due to dust trapped between the sheets, and the device can be assembled easily and the yield was high.

No bright lines were observed, which were often observed near the light source in conventional devices. The pattern of the light takeout mechanism 290 comprising the protrusions 29a can be changed easily. Thus, the appearance adjustment can be made in a short time.

### Comparative Example 2

A surface light source assembly was manufactured using the same light guide used in Example 5 and under the same conditions except that the reflective sheet was not of a two-layer structure but was formed by hot-pressing a non-oriented polycarbonate film having a thickness of 180 micrometers.

Easily recognizable patterns resulting from optical interference appeared on the light emitting surface. Due to variations in stress from the backside, the sheet deflected differently, which caused recognizable unevenness. The quality of picture was thus extremely low and the quality of illumination was insufficient for use as a backlight for large-sized liquid crystal display devices.

### Example 6

As the light guide 21, a 289.6×216.8 mm flat light guide 4.0 mm thick was used which was made of cyclic polyolefin resin (made by Zeon Corporation., Zeonor 1060R). Along the two long sides, a linear light source 22 in the form of a cold cathode tube (made by Harison Toshiba Lighting Corporation) having a tube diameter of 2.4 mm was provided. The cold cathode tube was covered by a reflector plate (made by Mitsui Chemicals Inc., silver reflector plate) of which the reflecting surface was an Ag deposit layer so that the light beams from the light source 22 would efficiently enter the light guide 21 through its light incoming surface 21b.

On the surface 21c of the light guide 21 opposite to the light emitting surface 21b, diamond-shaped (with four sides equal in length) protrusions 29′ having flat surfaces were formed by patterning such that the farther from the linear light source 22, the more the size increased. As shown in FIGS. 31 and 32(c), the protrusions 29a had a depth of 80.0 micrometers and a length of the diagonal line varying in the range of 113.0 μm to 171.0 μm.

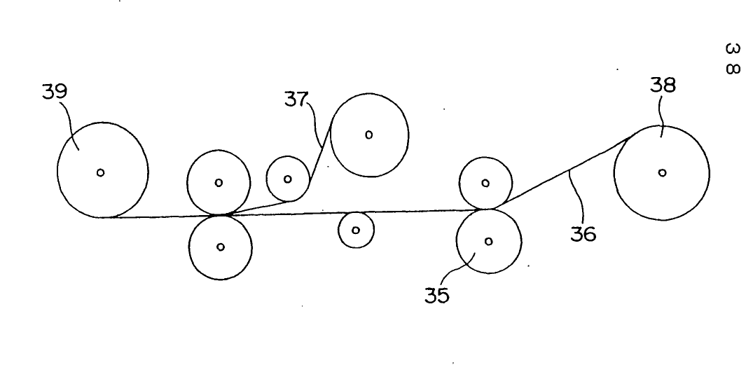

The mold used to form the protrusions 29′ was formed by laminating a dry film resist 35′ having a thickness of 100 μm on a mirror finished copper substrate 36′, putting a photomask 37′ thereon, forming a pattern by photolithography using parallel light source with dry film resist 35′ remaining at places where recesses were to be formed as shown in FIG. 35(b), and depositing nickel (Ni) as the metal plating layer 38′ on the copper substrate 36′ subjected to patterning to a predetermined film thickness.

Then the dry film resist 36′ was peeled to prepare a mold 40 formed with recesses 39′ (where protrusions are to be formed). By use of the thus obtained mold 40 formed with recesses 39, a light guide 21 formed with flat protrusions 29′ was formed by injection molding by use of an injection molding machine (made by Toshiba Machine Co., Ltd.).

In order to measure the emitting direction selectivity rate of the light guide 21, as shown in FIG. 12, a black sheet 30 of flock paper having a reflectance of 1% or less was arranged at a position where the reflective sheet 27 was to be placed, and the light emitting angle distribution in a given direction 101 in a plane that was perpendicular to the light incoming surface of the light guide 21 (the side 21a of the light guide 21 along which the light source 22 was provided) and was parallel to the normal line 23 was measured with a luminance meter (made by TopCom Inc., BM-7).

Next, with the light guide 21 turned over (so that the light emitting surface 21b would face the black sheet 30), the emitting angle distribution was measured in the same manner as above. The curves were integrated in the range of 0-180 degrees to determine values La and Lb. The emitting direction selectivity rate at the central position of the light emitting surface, which is given by Lb/(La+Lb), was 81.5%. Thus it was confirmed that an optical system was obtained with which light beams were emitted selectively toward the reflective sheet 27.

The reflective sheet 27 was used which had a shape shown in FIG. 5, and had as base units 28 reflecting surfaces 28a having parallel ridges 28b and having a serration-shaped section. The pitch P2 was 50 μm. For the reflecting layer, an aluminum deposit layer was used. On the aluminum deposit layer, silica was coated by sputtering.

The inclination angle α of the reflecting surfaces 28a was 33 degrees. An optical system was obtained in which light beams selectively directed toward the reflective sheet 27 were reflected by the reflective sheet 27, so that highly collective illuminating light emitted from the diamond-shaped smooth protrusions are emitted to a front direction (in a direction perpendicular to the light emitting surface of the light guide.

The cold cathode tube light source 22 was turned on at high frequency through the inverter (made by Harison Toshiba Lighting Corporation) to provide a surface light source. Even with careful view of the light emitting surface 21b, no Moire fringe or Newton ring was observed and the reflective sheet 27 deflected slightly, but no evenness in brightness was detected. As a result, the surface light source showed practically satisfactory appearance and quality.

The average brightness was measured at 5 points by use of a luminance meter (made by TopCom Inc., BM-7) with the tube current set at 5 mA. The average brightness was 2240 nit. Thus, it was confirmed that the optical characteristics were sufficient in both brightness and unevenness of brightness for use as a backlight for a liquid crystal display panel.

Since the illuminating light beams were sufficiently condensed both in the horizontal and vertical directions, their properties were sufficient for use as backlight particularly for liquid display devices used in laptop or notebook personal computers and handhold computers. Further, since it had no prism sheet, which was used in conventional arrangements, there was no need to worry about failure due to dust trapped between the sheets, and the device can be assembled easily and the yield was high.

No bright lines were observed, which were often observed near the light source in conventional devices. It was possible to change the pattern of the light takeout mechanism 290 comprising the protrusions 29a easily. Thus, it was possible to perform the appearance justment in a short time.

### Comparative Example 3

A surface light source assembly was prepared using the same light guide used in Example 6 under the same conditions except that the flat protrusions were rectangular as shown in FIG. 34(a).

While the emitting direction selectivity rate as measured in the same manner used in Example 6 was 83% and a light guide was obtained in which light beams emitted toward the reflective sheet exclusively, the average brightness at 25 points on the emitting surface was as low as 1879 nit, which shows lower optical efficiency compared with Examples.

### ADVANTAGES OF THE INVENTION

With the surface light guide according to the present invention, most of light beams entering the light guide are selectively directed toward the reflective sheet, then reflected by the reflective sheet, emitted in the front direction. If the condensing elements are provided on the emitting surface, the light guide itself serves as a lens array sheet. Thus, the surface light source assembly is superior in light collectivity, is simple in structure, easy to assemble, and inexpensive.

Such a device is free of striped unevenness due to optical interference, it can be advantageously used as a backlight for a large-sized liquid crystal display device.

1. A light guide for use with a surface light source device, said light guide comprising a light emitting surface on one surface thereof and a light takeout mechanism formed on a surface opposite said light emitting surface and comprising directional light emitting elements each having a smooth surface, said directional light emitting elements emitting at least 65% or more of light beams from the light guide through said surface opposite said light emitting surface.

2. The light guide claimed in claim 1 further comprising condensing elements provided on said light emitting surface.

3. A surface light source device comprising a light guide having a light emitting surface on one surface thereof, condensing elements provided on said light emitting surface, a light source provided along one side of said light guide, and a light reflective sheet provided on a surface of said light guide opposite said light emitting surface,
said light guide having on said surface opposite said light emitting surface a light takeout mechanism comprising directional light emitting elements each having a smooth surface, said reflective sheet having a multiplicity of substantially analogously shaped base units each having an inclined surface having a reflectance of 70% or higher and arranged with a pitch of 5000 micrometers or less.

4. The surface light source device claimed in claim 3 wherein said directional light emitting elements emit at least 65% or more of the light beams from said light guide toward said reflective sheet.

5. The surface light source device claimed in claim 3 or 4 wherein said directional light emitting elements comprise a multiplicity of protrusions each having a smooth surface which has an arithmetic average roughness Ra of 0.01-10 micrometers.

6. The surface light source device claimed in claim 5 wherein each of said protrusions has a depth h and a minimum opening width W min, and the ratio h/W min is 0.5 or higher.

7. The surface light source device claimed in claim 6 wherein each of said protrusions has a depth h and a maximum opening width W max, and the ratio h/W max is 0.3 or higher.

8. The surface light source device claimed in any of claims 5-7 wherein each of said protrusions has an opening width increasing as the distance from said light source increases in one axial direction.

9. The surface light source device claimed in any of claims 5-7 wherein said protrusions are substantially identical in shape and wherein the density of said protrusions increases as the distance from said light source increases.

10. The surface light source device claimed in any of claims 3-9 wherein said condensing elements are in the form of corrugations having ridges extending perpendicular to said side along which said light source is provided, and arranged with a pitch of 1-500 micrometers.

11. The surface light source device claimed in claim 10 wherein said corrugations form an array of triangular prisms having an apex angle of 70-150 degrees and arranged with a pitch of 5-300 micrometers.

12. The surface light source device claimed in any of claims 3-11 wherein said base units of said reflective sheet are chevron-shaped and have ridges arranged substantially parallel to each other.

13. The surface light source device claimed in claim 12 wherein said inclined surfaces of said base units of said reflective sheet have a concave cross-section.

14. The surface light source device claimed in any of claims 3-11 wherein said inclined surfaces of said base units of said reflective sheet are in the form of a concave mirror having a maximum diameter of 3000 micrometers or less, and said inclined surfaces are inclined so as to reflect light beams from said light guide in a normal direction of said light guide.

15. The surface light source device claimed in claim 13 or 14 wherein said reflective sheet has a reflective surface comprising a coating layer of silver or aluminum and is covered with a transparent coating layer.

16. The surface light source device claimed in claim 13 or 14 wherein said reflective surface of said reflective sheet is formed from a diffuse reflective white material.

17. A light guide for use with a surface light source device, said light guide comprising a light emitting surface on one surface thereof and a light takeout mechanism for selectively emitting light beams through a surface opposite said light emitting surface, the emitting direction selectivity rate as measured at any point in said light emitting surface being substantially constant.

18. The light guide claimed in claim 17 wherein said emitting direction selectivity rate as measured at any point in said light emitting surface is 60-100% and varies in the range of ±30% of the average light emitting direction selectivity rate.

19. The light guide claimed in claim 17 or 18 wherein said light takeout mechanism comprises protrusions formed on said surface opposite said light emitting surface and each having a smooth surface.

20. The light guide claimed in claim 19 wherein said protrusions have a protruding amount of 300 micrometers or less, a depth h and an effective opening width W, the ratio h/W being 0.3-1.5, said protrusions having a length increasing in one axial direction as the distance from said light source increases, said one axial direction being parallel to the side of said light guide along which said light source is provided.

21. A surface light source device comprising a light guide having a light emitting surface on one surface thereof, a light takeout mechanism provided on said light guide, a light source provided along one side of said light guide, and a light reflective sheet provided on a surface of said light guide opposite said light emitting surface and having a multiplicity of substantially identically and/or substantially analogously shaped base units each having an inclined light reflective sheet and arranged with a pitch of 5000 micrometers or less,
characterized in that said light takeout mechanism is adapted to selectively emit light beams toward said light reflective sheet and a light emitting direction selectivity rate as measured at any point in said light emitting surface is substantially constant.

22. The surface light source device claimed in claim 21 wherein said emitting direction selectivity rate as measured at any point in said light emitting surface is 60-100% and varies in the range of ±30% of the average light emitting direction selectivity rate.

23. The surface light source device claimed in claim 21 or 22 wherein said light takeout mechanism comprises protrusions formed on said surface opposite said light emitting surface and each having a smooth surface.

24. The light guide claimed in claim 23 wherein said protrusions have a protruding amount of 300 micrometers or less, a depth h and an effective opening width W, the ratio h/W is 0.3-1.5, said protrusions having a length increasing in one axial direction as the distance from said light source increases, said one axial direction being parallel to the side of said light guide along which said light source is provided.

25. The surface light source device claimed in claim 23 wherein said protrusions have a protruding amount of 300 micrometers or over, a depth h and an effective opening width W, the ratio h/W is 0.3-1.5, and said protrusions are substantially identical in shape, the density of said protrusions increases as the distance from said light source increases.

26. The surface light source device claimed in claim 24 or 25 further comprising an array of triangular prism arranged with a pitch of 1-500 micrometers and having ridges extending substantially perpendicular to said side along which said light source is provided, and having an apex angle between 150 and 60 degrees.

27. A light guide for use with a surface light source device, said light guide having a light emitting surface on one surface thereof, and a light reflective sheet provided on a surface opposite said light emitting surface and comprising a multiplicity of substantially identically and/or substantially analogously shaped base units each having an inclined light reflective surface, and a light source provided along one side of said light guide,
characterized in that said light guide includes a light takeout mechanism for selectively emitting a major portion of illuminating light beams through said surface opposite said light emitting surface, and said light takeout mechanism has an irregular pattern.

28. The light guide claimed in claim 26 wherein the emitting direction selectivity rate at or near the center of said light emitting surface is 60-100%.

29. The light guide claimed in claim 27 or 28 wherein condensing elements are provided on said light emitting surface, said condensing elements having ridges extending substantially perpendicular to said side along which said light source is provided, and being arranged with a pitch of 1-500 micrometers.

30. The light guide claimed in claim 28 wherein said condensing elements comprise an array of triangular prism having an apex angle of 60-150 degrees and arranged with a pitch of 10-150 micrometers.

31. The light guide claimed in any of claims 27-30 wherein said light takeout mechanism having an irregular pattern comprises protrusions each having a smooth surface and having a protruding amount of 2-300 micrometers.

32. The light guide claimed in claim 31 wherein said protrusions are not in contact with each other in said light emitting surface.

33. The light guide claimed in any of claims 27-30 wherein said light takeout mechanism having an irregular pattern has a dot pattern comprising rough surfaces.

34. A surface light source device comprising the light guide as claimed in any of claims 27-33, and a light source provided at one side of said light guide, and a light reflective sheet arranged on a surface opposite said light emitting surface, substantially identically and/or substantially analogously shaped base units each having a reflective surface being arranged on said reflective sheet with a pitch of not more than 5000 micrometers.

35. The surface light source device claimed in claim 34 wherein said inclined surfaces of said base units of said reflective sheet are chevron-shaped and have ridges juxtaposed to those of adjacent ones of said ridges.

36. The surface light source device claimed in claim 35 wherein said inclined surfaces of said base units of said reflective sheet have a concave cross-section.

37. A light guide having a light incoming surface at one side thereof and a light emitting surface on one surface thereof,
said light guide including a light takeout mechanism comprising protrusions for emitting a major portion of illuminating light through a surface opposite said light emitting surface, said protrusions protruding in a direction in which a major portion of the illuminating light proceeds as viewed from right over said light emitting surface.

38. The light guide claimed in claim 37 wherein the emitting direction selectivity rate at or near the center of said light emitting surface is 70-100%.

39. The light guide claimed in claim 38 wherein said light takeout mechanism comprising protrusions is provided on said surface opposite said light emitting surface, said protrusions have a protruding amount of 2300 micrometers, and have a triangular, rectangular or oval cross-section as viewed from right over said light emitting surface.

40. The light guide claimed in claim 38 or 39 wherein said protrusions are irregularly arranged as viewed from right over said light emitting surface.

41. A surface light source device comprising the light guide as claimed in any of claims 37-40, a light source provided at one side of said light guide, a light reflective sheet provided to face said surface opposite said light emitting surface,
said reflective sheet having substantially identically and/or substantially analogously shaped base units having inclined light reflective surfaces and arranged with a pitch not exceeding 5000 micrometers.

42. The surface light source device claimed in 41 wherein said base units of said reflective sheet have a chevron-shaped cross-section and have ridges juxtaposed to those of adjacent base units.

43. The surface light source device claimed in 42 wherein said reflecting surfaces of said base units of said reflective sheet have a concave cross-section.

44. A light reflective sheet comprising a surface layer formed with substantially identically and/or substantially analogously shaped base units having inclined light reflecting surfaces and arranged with a pitch not exceeding 5000 micrometers, and a backing layer supporting said surface layer, said backing layer being made from a biaxially oriented thermoplastic resin film.

45. The light reflective sheet claimed in claim 44 wherein said biaxially oriented thermoplastic resin film is a film of polyethylene terephthalate or polypropylene.

46. The light reflective sheet claimed in claim 44 or 45 which is warped so as to be convex toward said surface layer.

47. The light reflective sheet claimed in any of claims 44-46 wherein said light reflecting surfaces are formed of a metallic material, and a coating layer of a transparent insulating layer is provided on said metallic material.

48. A method of manufacturing the light reflective sheet of claims 44-47, wherein said base units are formed by a roll-to-roll process.

49. A method of manufacturing the light reflective sheet of claims 44-47, wherein said base units are formed by shape transfer using emboss rolls.

50. A surface light source device comprising a light guide having a light emitting surface on one surface thereof, a light takeout mechanism provided on said light guide, a light source provided along one side of said light guide, and the light reflective sheet of any of claims 44-47, said light reflective sheet being provided to face a surface opposite said light emitting surface.

51. The surface light source device claimed in claim 50 wherein the emitting direction selectivity rate at or near the center of said light emitting surface is 60-100%.

52. The surface light source device claimed in claim 50 or 51 wherein on said light emitting surface of said light guide, condensing elements in the form of an array of triangular prism are provided, said triangular prisms having ridges extending substantially perpendicular to said one side of said light guide and arranged with a pitch of 10-150 micrometers and having an apex angle of 60-150 degrees.

53. The surface light source device claimed in any of claims 50-52 wherein said light takeout mechanism comprises irregularly arranged protrusions each having a smooth surface and a protruding amount of 2-300 micrometers.

54. The surface light source device claimed in any of claims 50-52 wherein said light takeout mechanism has a pattern comprising irregularly arranged rough surfaces.

55. A liquid crystal display device including as its backlight the surface light source device claimed in any of claims 3-11, 13-16, 21-26, 34-36, 41-43 and 50-54.
